(19) United States
(12) Patent Application Publication
(10) Pub. No.: US 2019/0011699 A1
(43) Pub. Date: Jan. 10, 2019

(54) SYSTEMS, DEVICES, AND METHODS FOR REDUCING BULK AND BALANCING WEIGHT IN WEARABLE HEADS-UP DISPLAYS

(71) Applicant: THALMIC LABS INC., Kitchener (CA)

(72) Inventors: Joshua Moore, Elora (CA); Lloyd Frederick Holland, Kitchener (CA); Stephen Lake, Kitchener (CA); George Shaker, Waterloo (CA)

(21) Appl. No.: 16/130,829

(22) Filed: Sep. 13, 2018

Related U.S. Application Data
(63) Continuation-in-part of application No. 14/704,663, filed on May 5, 2015.
(60) Provisional application No. 61/989,848, filed on May 7, 2014.
(60) Provisional application No. 62/609,607, filed on Dec. 22, 2017.
(60) Provisional application No. 62/609,681, filed on Dec. 22, 2017.
(60) Provisional application No. 62/670,200, filed on May 11, 2018.

(51) Int. Cl. G02B 27/01

(52) U.S. Cl. CPC G02B 27/0101; G02B 27/0172; G02B 2027/0152; G02B 2027/013; G02B 2027/015; G02B 27/0149

(57) ABSTRACT

Systems, devices, and methods for reducing bulk and balancing weight in wearable heads-up displays are described. Bulk can be reduced in a wearable heads-up display by positioning a battery in a first arm of the wearable heads-up display and other electronics in a second arm of the wearable heads-up display, thus reducing the amount of extraneous housing that would otherwise be required to house multiple batteries or electronic components in both arms. Weight of a wearable heads-up display can be balanced by selecting appropriately sized and weight electronics in the first arm, and by adjusting size and therefore weight of the battery in the second arm. Densely filling the first arm with electronics can result in the first arm and the second arm having similar weight.

### BACKGROUND

### Technical Field

The present systems, devices, and methods generally relate to wearable heads-up displays and particularly relate to minimizing bulk and achieving ergonomics and balance in wearable heads-up displays while maintaining high performance.

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be “wireless” (i.e., designed to operate without any wire-connections to other, non-portable electronic systems); however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

Because they are worn on the body of the user, and typically visible to others, and generally present for long periods of time, form factor (i.e., size, geometry, and appearance) is a major design consideration in wearable electronic devices.

### Wearable Heads Up Displays

A head-mounted display is an electronic device that is worn on a user's head and, when so worn, secures at least one electronic display within a viewable field of at least one of the user's eyes. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Microsoft Hololens® just to name a few.

The optical performance of a wearable heads-up display is an important factor in its design. When it comes to face-worn devices, however, users also care a lot about aesthetics. This is clearly highlighted by the immensity of the eyeglass (including sunglass) frame industry. Independent of their performance limitations, many of the aforementioned examples of wearable heads-up displays have struggled to find traction in consumer markets because, at least in part, they lack fashion appeal. Most wearable heads-up displays presented to date employ large display components and, as a result, most wearable heads-up displays presented to date are considerably bulkier and less stylish than conventional eyeglass frames.

Additionally, users also care a lot about comfort. Since wearable heads-up displays are intended to be worn on the face of a user, wearable heads-up displays should comfortable, otherwise the user will quickly remove the wearable heads-up display due to strain. Wearable heads-up displays tend to be uncomfortable when they are too bulky or have unbalanced bulk.

A challenge in the design of wearable heads-up displays is to minimize and balance the bulk, volume, and weight of the face-worn apparatus while still providing displayed content with sufficient visual quality. There is a need in the art for wearable heads-up displays of more aesthetically-appealing and comfortable design that are capable of providing high-quality images to the user without limiting the user's ability to see their external environment.

### BRIEF SUMMARY

According to a broad aspect, the description describes a wearable heads-up display (“WHUD”) comprising: a support structure to be worn on a head of a user, the support structure comprising a first arm to be positioned on a first side of the head of the user, a second arm to be positioned on a second side of the head of the user opposite the first side of the head of the user, and a front frame to be positioned on a front side of the head of the user, the front frame physically coupled to the first arm and the second arm; an optical combiner carried by the front frame to be positioned within a field of view of an eye of the user; a light engine carried by the first arm, the light engine positioned and oriented to output display light to the optical combiner; a battery carried by the second arm; and at least one connector which electrically couples the battery to the light engine, wherein the optical combiner is positioned and oriented to direct the display light towards the eye of the user.

The WHUD may further comprise at least one processor carried by the first arm and a non-transitory processor readable medium carried by the first arm, wherein the at least one processor is communicatively coupled to the non-transitory processor readable medium and the light engine, and the at least one connector electrically couples the battery to the at least one processor and to the non-transitory processor readable storage medium.

The WHUD may further comprise a power supply circuit carried by the first arm, wherein the at least one connector directly electrically couples the battery to the power supply circuit, and the power supply circuit is electrically coupled to the at least one processor, the non-transitory processor readable medium, and the light engine.

The at least one connector may directly electrically couple the battery to the at least one processor, the non-transitory processor readable medium, and the light engine.

The WHUD may further comprise a wireless communication module operable to provide wireless communications with one or more other electronic devices, wherein at least a portion of the wireless communication module is positioned on the support structure relative to the light engine.

The wireless communication module may comprise a wireless receiver communicatively coupled to the light engine, wherein the at least one connector electrically couples the battery to the wireless receiver.

The first arm may be positioned on a right side of the head of the user and the second arm may be positioned on a left side of the head of a user.

The first arm may be positioned on a left side of the head of the user and the second arm may be positioned on a right side of the head of the user.

The light engine may comprise a projector, a scanning laser projector, a microdisplay, or a white-light source.

The optical combiner may comprise: a lightguide, at least one hologram, at least one prism, a diffraction grating, at least one light reflector, or at least one light refractor positioned and oriented to redirect the display light towards the eye of the user.

The optical combiner may be carried by a lens carried by the front frame of the support structure.

The light engine may include a scanning laser projector and the optical combiner may include at least one hologram, wherein the scanning laser projector is positioned and oriented to project laser light onto the at least one hologram, and the at least one hologram is positioned and oriented to redirect the laser light towards an eye of the user.

The WHUD may further comprise a light redirector, wherein: the light redirector is positioned and oriented to receive the display light output by the light engine and to redirect the display light into a periphery of the optical combiner; and the optical combiner comprises a lightguide and an out-coupler, wherein the lightguide is positioned and oriented to receive the display light from the light redirector and direct the display light to the out-coupler, and the out-coupler is positioned and oriented to redirect the display light towards the eye of the user.

The at least one connector may be carried by the front frame.

The at least one connector may be positioned behind a head of the user.

The front frame may be directly physically coupled to the first arm and the second arm.

The front frame may be indirectly physically coupled to the first arm via a first intermediary coupler, and the front frame may be indirectly physically coupled to the second arm via a second intermediary coupler.

According to another broad aspect, the description describes a wearable heads-up display (“WHUD”) comprising: a support structure to be worn on a head of a user, the support structure comprising a first arm to be positioned on a first side of the head of the user, a second arm to be positioned on a second side of the head of the user opposite the first side of the head of the user, and a front frame to be positioned on a front side of the head of the user, the front frame physically coupled to the first arm and the second arm; an optical combiner carried by the front frame to be positioned within a field of view of an eye of the user; a light engine carried by the front frame, the light engine positioned and oriented to output display light into a periphery of the optical combiner; a non-transitory processor-readable medium carried by the first arm; at least one processor carried by the first arm, the at least one processor communicatively coupled to the non-transitory processor readable medium and the light engine; a battery carried by the second arm; and at least one connector which electrically couples the battery to the light engine, the non-transitory processor-readable medium, and the at least one processor, wherein the optical combiner is positioned and oriented to direct the display light towards the eye of the user.

The WHUD may further comprise a power supply circuit carried by the first arm, wherein the at least one connector directly electrically couples the battery to the power supply circuit, and the power supply circuit is electrically coupled to the at least one processor, the non-transitory processor readable medium, and the light engine.

The at least one connector may directly electrically couple the battery to the at least one processor, the non-transitory processor readable medium, and the light engine.

The WHUD may further comprise a wireless communication module operable to provide wireless communications with one or more other electronic devices, wherein at least a portion of the wireless communication module is positioned on the support structure relative to the light engine.

The wireless communication module may comprise a wireless receiver communicatively coupled to the light engine, wherein the at least one connector electrically couples the battery to the wireless receiver.

The first arm may be positioned on a right side of the head of the user and the second arm may be positioned on a left side of the head of a user.

The first arm may be positioned on a left side of the head of the user and the second arm may be positioned on a right side of the head of the user.

The light engine may comprise a projector, a scanning laser projector, a microdisplay, or a white-light source.

The optical combiner may comprise a lightguide and an out-coupler, wherein the lightguide is positioned and oriented to receive the display light from the light engine and direct the display light to the out-coupler, and the out-coupler is positioned and oriented to redirect the display light towards the eye of the user.

The optical combiner may be carried by a lens carried by the front frame of the support structure.

The at least one connector may be carried by the front frame.

The at least one connector may be positioned behind a head of the user.

The front frame may be directly physically coupled to the first arm and the second arm.

The front frame may be indirectly physically coupled to the first arm via a first intermediary coupler, and the front frame may be indirectly physically coupled to the second arm via a second intermediary coupler.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a partial-cutaway perspective diagram of an exemplary wearable heads-up display (“WHUD”) in accordance with the present systems, devices, and methods.

FIG. 2 is a top view of a WHUD in accordance with an exemplary implementation having a connector which electrically couples electrical components carried by a first arm of a WHUD with a battery carried by a second arm of the WHUD.

FIG. 3 is a top view of a WHUD in accordance with an exemplary implementation having an alternative connector position.

FIG. 4 is a top view of a WHUD in accordance with an exemplary implementation in which electrical components carried by a first arm of a WHUD are powered directly without a power supply circuit in the first arm.

FIG. 5 is a top view of a WHUD having a plurality of connectors and a plurality of battery cells in accordance with an exemplary implementation.

FIG. 6 is a front view of a WHUD showing alternative or complementary connector paths in accordance with an exemplary implementation.

FIG. 7 is a top view of a WHUD where some or all of processing performed is offboarded to a peripheral device in accordance with an exemplary implementation.

FIG. 8 is a top view of a WHUD with reversed orientation in accordance with an exemplary implementation.

FIGS. 9, 10, and 11 are top views of WHUDs having alternative display architectures and support structures in accordance with at least three exemplary implementations.

FIG. 12 is a top view of a WHUD having a first arm and a second arm indirectly coupled to a front frame via intermediary couplers in accordance with an exemplary implementation.

FIG. 13A is an illustrative diagram of a wearable computer system that includes a wearable electronic band wirelessly communicatively coupled to a peripheral WHUD in accordance with the present systems, devices, and methods.

FIG. 13B is an alternate illustrative view of the wearable computer system in FIG. 13A.

FIG. 14 is a perspective view of a WHUD operable for wireless communication with electronic devices in accordance with an exemplary implementation.

FIG. 15 is a partial view of arm supports having a power source and wireless communication hardware in accordance with an exemplary implementation.

FIG. 16 is a top plan view of a WHUD having projector hardware and wireless communication hardware in accordance with an exemplary implementation.

FIG. 17 is a side elevation view of a WHUD having projector hardware and wireless communication hardware in accordance with an exemplary implementation.

FIG. 18 is a perspective view of an exemplary implementation of eyeglasses having an antenna and a power source incorporated in the eyeglasses.

FIG. 19 is a perspective view of an alternative exemplary implementation of eyeglasses having an antenna and a power source incorporated in the eyeglasses.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

Throughout the figures, several components are illustrated with dashed lines, to indicate that the respective component is not normally visible from the illustrated perspective of the drawing, but rather is contained within a housing of the device or otherwise occluded in the illustrated perspective. However, one skilled in the art will appreciate that any of the components illustrated with dashed lines need not be encased within a housing of the device, but could instead be located externally such as on the surface of the device.

The various embodiments described herein provide systems, devices, and methods for balancing wearable heads-up displays to minimize bulk and achieve ergonomics and balance, while maintaining high performance of the wearable heads-up display. In wearable heads-up displays, there is typically a struggle to fit powerful technology and hardware in a device, while making the device small and light enough to be comfortable and aesthetically pleasing on a user's face. Typically, a wearable heads-up display will include some kind of display element, as well as a battery to power the display element. The hardware in the display element often requires bulky optics and light modules. Further, in order to achieve a reasonable battery life for the device, the battery typically will be bulky and heavy. Fitting these bulky and heavy components into a device the size of eyeglasses has proven to be a significant challenge, especially when considering that all of the components must not only fit in the device, but also must have balanced weight to prevent strain and discomfort to the user, and also should have balanced volume to achieve an aesthetically appealing symmetrical design.

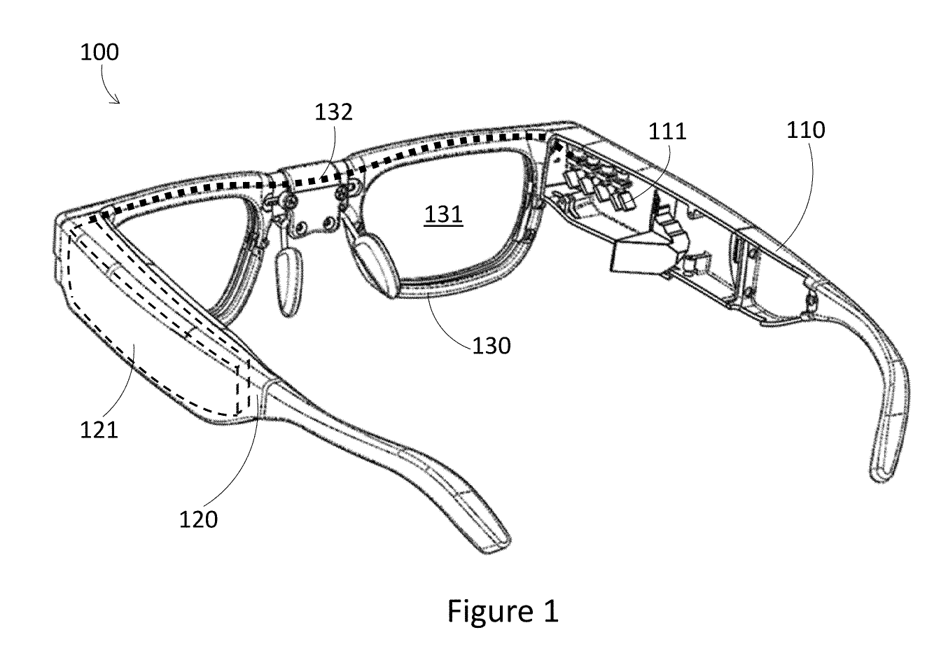

FIG. 1 is a partial-cutaway perspective diagram of an exemplary wearable heads-up display (“WHUD”) 100 in accordance with the present systems, devices, and methods. WHUD 100 includes a first arm 110, a second arm 120, and a front frame 130 which is physically coupled to first arm 110 and second arm 120. When worn by a user, first arm 110 is to be positioned on a first side of a head of the user, second arm 120 is to be positioned on a second side of a head of a user opposite the first side of the head of the user, and front frame 130 is to be positioned on a front side of the head of a user. The term “arm support” can used be used in place of the term “arm” herein. First arm 110 carries a light engine 111 which outputs light representative of display content to be viewed by a user. First arm 110 may also optionally carry several additional components of WHUD 100, as will be discussed in more detail later. Second arm 120 carries a battery 121 which powers the components of WHUD 100. Front frame 130 carries an optical combiner 131 which receives light output from the light engine 111 and redirects this light to form a display to be viewed by a user. Front frame 130 also carries a connector 132 which electrically couples battery 121 to light engine 111, and any other electrical components carried by first arm 110.

Light engine 111 and optical combiner 131 can include any appropriate display architecture for outputting light and redirecting the light to form a display to be viewed by a user. For example, light engine 111 could include at least one of a projector, a scanning laser projector, a microdisplay, a white-light source, or any other display technology as appropriate for a given application. Optical combiner 131 could include at least one holographic optical element, optical waveguide, liquid crystal display, diffraction grating, reflector array, refractor array, or any other light-redirection technology as appropriate for a given application. Optical combiner 131 can be carried by a lens carried by front frame 130. For example, optical combiner 131 could be: a layer formed as part of a lens, a layer adhered to a lens, a layer embedded within a lens, a layer sandwiched between at least two lenses, or any other appropriate arrangement. A layer can for example be molded or cast, and/or could include a thin film and/or coating. Alternatively, optical combiner 131 could be a lens carried by front frame 130. Further, a “lens” as used herein can refer to a lens which applies no optical power and does not correct a user's vision, or a “lens” can be a prescription lens which applies an optical power to incoming light to correct a user's vision.

Exemplary display architectures could include for example scanning laser projector and holographic optical element combinations, side-illuminated optical waveguide displays, pin-light displays, or any other wearable heads-up display technology as appropriate for a given application. Exemplary display architectures are described in at least U.S. Non-Provisional patent application Ser. No. 15/145,576, U.S. Non-Provisional patent application Ser. No. 15/167,458, U.S. Non-Provisional patent application Ser. No. 15/046,254 now published as U.S. Pat. No. 9,989,764, and U.S. Provisional Patent Application Ser. No. 61/928,568 (now U.S. Non-Provisional patent application Ser. No. 14/599,279). Alternative terms for “light engine” as used herein could include light source, projector, display light engine, display output, or any other appropriate terminology. Alternative terms for “optical combiner” as used herein can include transparent combiner, holographic optical element, holographic combiner, or any other appropriate terminology.

Advantageously, by positioning a majority of electrical components in a first arm, and positioning a battery in a second arm, space can be utilized efficiently, which reduces overall bulk and volume of the WHUD. For example, if a smaller battery were carried by both the first arm and the second arm, each battery would require a separate housing, which occupies space. By having a unified battery carried by the second arm, and having the second arm largely or entirely devoted to carrying the battery, space occupied by battery housing can be decreased, thus reducing the overall bulk and improving space efficiency of the WHUD. Further, weight balance can be achieved by carefully selecting appropriate electrical and optical components to be carried by the first arm, to match the weight of the battery. By selecting components of appropriate size and weight, and/or by filling the first arm densely enough with components, the first arm and the second arm can be designed to have similar weight. If necessary, additional weight can be added to the first arm by selecting a denser or thicker housing material for the first arm, or by adding “ballast” material to the first arm, i.e., excess material included solely for the purpose of increasing the weight of the first arm to match the second arm. It is also possible to reduce the size of the battery in order to reduce the weight of the second arm to match the weight of the first arm. Further, it is also possible to adjust the form factor of the first arm and/or the second arm to achieve volume and/or weight balance for aesthetics and comfort. As an example, the components in the first arm may necessitate a certain shape for the first arm, and the second arm and battery shape can be designed to match the shape of the first arm. Similarly, a certain shape of the second arm may be required to house an adequate battery therein, and the first arm can be designed to have a certain shape to match the shape of the second arm, with the components in the first arm being selected and arranged to fit within the designed shape.

Several exemplary WHUDs are described below, which further illustrate various features of the present systems, devices, and methods. One skilled in the art will appreciate that the specific features described in the below implementations can be combined as appropriate, such that the present disclosure is not restricted to only the implementations discussed below, but also includes any reasonable combination of the features of the implementations discussed herein.

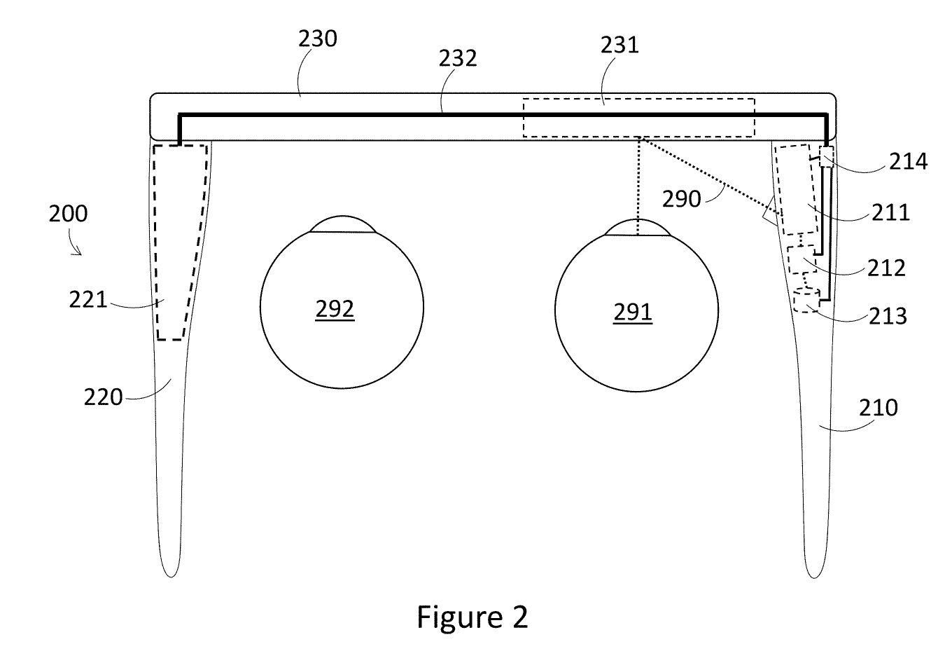

FIG. 2 is a top view of a WHUD 200 positioned relative to a pair of eyes 291, 292 in accordance with an exemplary implementation. Similar to WHUD 100, WHUD 200 includes a first arm 210, a second arm 220, and a front frame 230. First arm 210 carries light engine 211, at least one processor 212, non-transitory processor-readable medium 213, and power supply circuit 214. Second arm 220 carries battery 221. Front frame 230 carries optical combiner 231 and connector 232. Connector 232 electrically couples battery 221 to power supply circuit 214. Power supply circuit 214 then provides power to each of light engine 211, at least one processor 212, and non-transitory storage medium 213, and any other electrical components that may be carried by first arm 210. In this way, connector 232 electrically couples battery 221 to each of light engine 211, at least one processor 212, and non-transitory storage medium 213, and any other electrical components that may be carried by first arm 210, via power supply circuit 214. Power supply circuit 214 can optionally modulate the power from battery 221, such as by modulating the voltage or current of the power to be delivered to each of the electrical components. Each electrical component may receive the same modulated power signal from power supply circuit 214, each component may receive a different modulated power signal from power supply circuit 214, or some components may receive the same modulated power signal from power supply circuit 214 while other components receive a different modulated power signal from power supply circuit 214.

The at least one processor 212 can be communicatively coupled to each of the electrical components in WHUD 200, including but not limited to light engine 211, non-transitory processor readable medium 213, and power supply circuit 214. The at least one processor 212 can be any suitable component which can execute instructions or logic, including but not limited to a micro-controller, microprocessor, multi-core processor, integrated-circuit, ASIC, FPGA, programmable logic device, or any appropriate combination of these components. Non-transitory processor-readable medium 213 may store processor readable instructions thereon, which when executed by at least one processor 212 can cause light engine 211 to output light 290 representative of display content to be viewed by a user. The output light 290 representative of display content to be viewed by a user is redirected by optical combiner 231 towards an eye 291 of the user, such that the user can see the display content. Further, non-transitory processor-readable medium 213 may store processor readable instructions thereon, which when executed by at least one processor 212 can cause the at least one processor to execute any number of functions, including receiving user input, managing user interfaces, generating display content to be presented to a user, receiving and managing data from any sensors carried by WHUD 200, receiving and processing external data and messages, and/or any other functions as appropriate for a given application. The non-transitory processor-readable medium 213 can be any suitable component which can store instructions, logic, or programs, including but not limited to non-volatile or volatile memory, read only memory (ROM), random access memory (RAM), FLASH memory, registers, magnetic hard disk, optical disk, or any combination of these components.

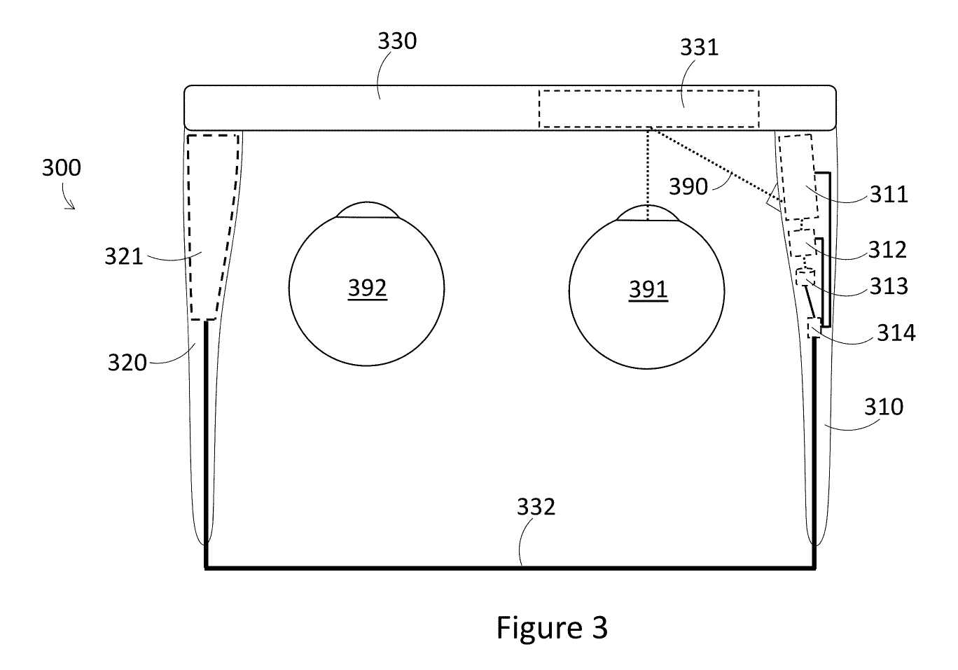

FIG. 3 is a top view of a WHUD 300 positioned relative to a pair of eyes 391, 392 in accordance with an exemplary implementation. WHUD 300 is similar in at least some respects to WHUD 200 illustrated in FIG. 2, and much of the description regarding FIG. 2 is applicable to FIG. 3. Specifically, the following table illustrates elements of FIG. 2 which may be similar or even identical to elements of FIG. 3:

| Element in FIG. 2 | Element in FIG. 3 |
|---|---|
| First arm 210 | First arm 310 |
| Light engine 211 | Light engine 311 |
| At least one processor 212 | At least one processor 312 |
| Non-transitory processor-readable | Non-transitory processor-readable |
| medium 213 | medium 313 |
| Power supply circuit 214 | Power supply circuit 314 |
| Second arm 220 | Second arm 320 |
| Battery 221 | Battery 321 |
| Front frame 230 | Front frame 330 |
| Optical combiner 231 | Optical combiner 331 |
| Output light 290 | Output light 390 |
| User eye 291 | User eye 391 |

One skilled in the art will appreciate that the description relating to each element in either Figure is applicable to the corresponding element in the other Figure.

One difference between FIGS. 2 and 3 is the location of the connector. Specifically, in FIG. 3, connector 332 serves the same purpose of electrically coupling the battery 321 to each of the light engine 311, at least one processor 312, non-transitory processor-readable medium 313, and any other electrical components via power supply circuit 314. However, rather than being carried by front frame 330, connector 332 instead extends out of the back end of second arm 320, and connects into the back end of first arm 310, such that the connector will be behind the head of a user when WHUD 300 is worn. This will reduce the weight of the front of WHUD 300, by moving the weight of connector 332 behind the user's head.

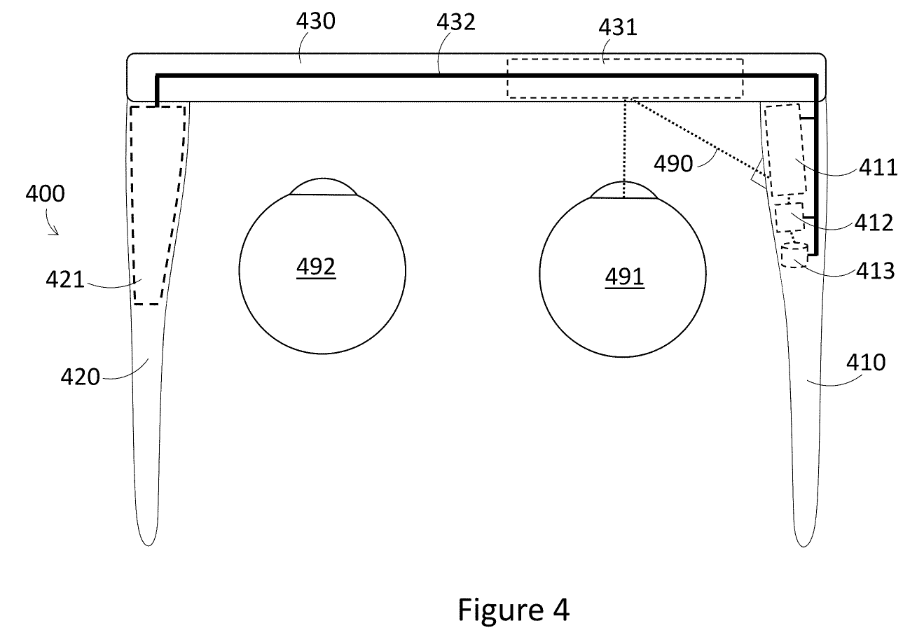

FIG. 4 is a top view of a WHUD 400 positioned relative to a pair of eyes 491, 492 in accordance with an exemplary implementation. WHUD 400 is similar in at least some respects to WHUD 200 illustrated in FIG. 2, and much of the description regarding FIG. 2 is applicable to FIG. 4. Specifically, the following table illustrates elements of FIG. 2 which may be similar or even identical to elements of FIG. 4:

| Element in FIG. 2 | Element in FIG. 4 |
|---|---|
| First arm 210 | First arm 410 |
| Light engine 211 | Light engine 411 |
| At least one processor 212 | At least one processor 412 |
| Non-transitory processor-readable | Non-transitory processor-readable |
| medium 213 | medium 413 |
| Second arm 220 | Second arm 420 |
| Battery 221 | Battery 421 |
| Front frame 230 | Front frame 430 |
| Optical combiner 231 | Optical combiner 431 |
| Output light 290 | Output light 490 |
| User eye 291 | User eye 491 |

One skilled in the art will appreciate that the description relating to each element in either Figure is applicable to the corresponding element in the other Figure.

One difference between WHUD 200 and WHUD 400 is that WHUD 400 does not include a power supply circuit corresponding to power supply circuit 214. Rather, battery 421 directly supplies power to each of light engine 411, at least one processor 412, non-transitory processor-readable medium 413, and any other electrical components of WHUD 400. This can be achieved by, for example, designing battery 421 to output a consistent power signal to each of the electrical components, or by including a power supply circuit within battery 421 which modulates power output by the battery 421 for each of the electrical components.

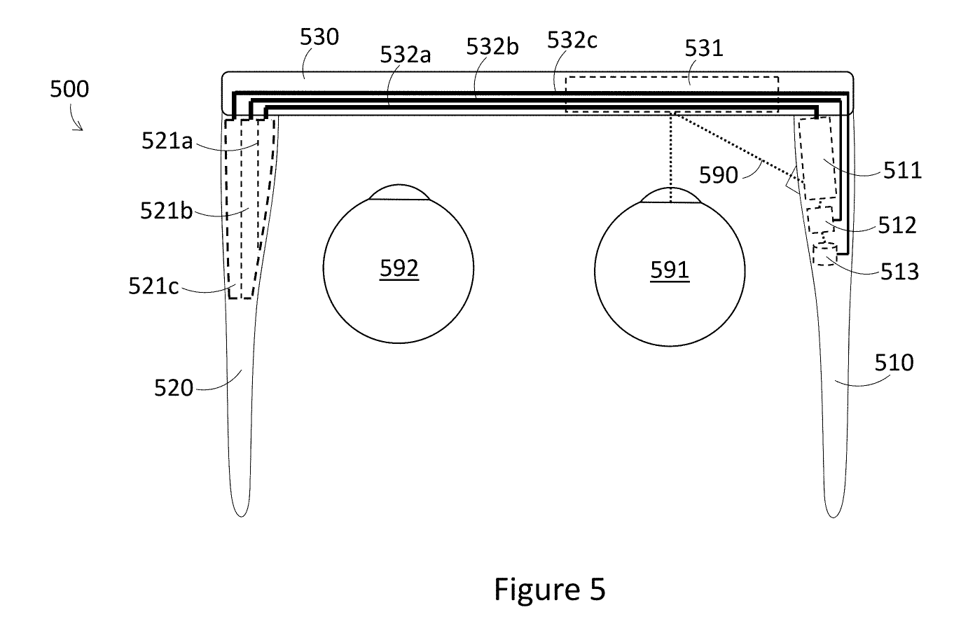

FIG. 5 is a top view of a WHUD 500 positioned relative to a pair of eyes 591, 592 in accordance with an exemplary implementation. WHUD 500 is similar in at least some respects to WHUD 400 illustrated in FIG. 4, and much of the description regarding FIG. 4 is applicable to FIG. 5. Consequently, much of the description of FIG. 2 is also applicable to FIG. 5. The following table illustrates elements of FIG. 4 which may be similar or even identical to elements of FIG. 5:

| Element in FIG. 4 | Element in FIG. 5 |
|---|---|
| First arm 410 | First arm 510 |
| Light engine 411 | Light engine 511 |
| At least one processor 412 | At least one processor 512 |
| Non-transitory processor-readable | Non-transitory processor-readable |
| medium 413 | medium 513 |
| Second arm 420 | Second arm 520 |
| Front frame 430 | Front frame 530 |
| Optical combiner 431 | Optical combiner 531 |
| Output light 490 | Output light 590 |
| User eye 491 | User eye 591 |

One skilled in the art will appreciate that the description relating to each element in either Figure is applicable to the corresponding element in the other Figure.

A first difference between WHUD 400 and WHUD 500 is that the connector of WHUD 500 is explicitly shown as including multiple connectors 532a, 532b, and 532c. Each connector could be run as a single separate wire, or the connectors could together make up a ribbon cable, wiring harness, or similar grouped connector arrangement. Each connector may carry the same power signal, each connector may carry a different power signal, or subsets of the multiple connectors could carry the same power signal which is different from a power signal carried by different subsets of the multiple connectors. In an exemplary implementation, a power supply circuit could be included in second arm 520, such that the battery provides power to the power circuit, which subsequently modulates the power and outputs power signals to multiple connectors, which in turn connect to electrical components in the first arm 510. In this way, the power providing components of WHUD 500 can be housed together in the second arm 520, and other electrical components such as processing and display components can be housed together in the first arm 510. One skilled in the art will appreciate that even though many other implementations described herein only explicitly show a single connector, each of the single connectors in any given implementation could instead comprise a plurality of connectors as appropriate.

A second difference between WHUD 400 and WHUD 500 is that the battery of WHUD 500 is shown as comprising a plurality of cells 521a, 521b, and 521c. In an exemplary implementation, each of these battery cells can output power with the same voltage, such that the different cells are simply redundant with each other to provide additional power, or so that an individual connector will electrically couple a given cell to a specific electrical component or subset of electrical components. In an alternative exemplary implementation, different battery cells can output different voltage from each other. Consequently, different cells can be utilized which provide different power output for different electrical components, such that each cell could be electrically connected to a specific electrical component or a set of electrical components via a specific connector. Different connectors could be used to connect the other cells to other electrical components in the same manner.

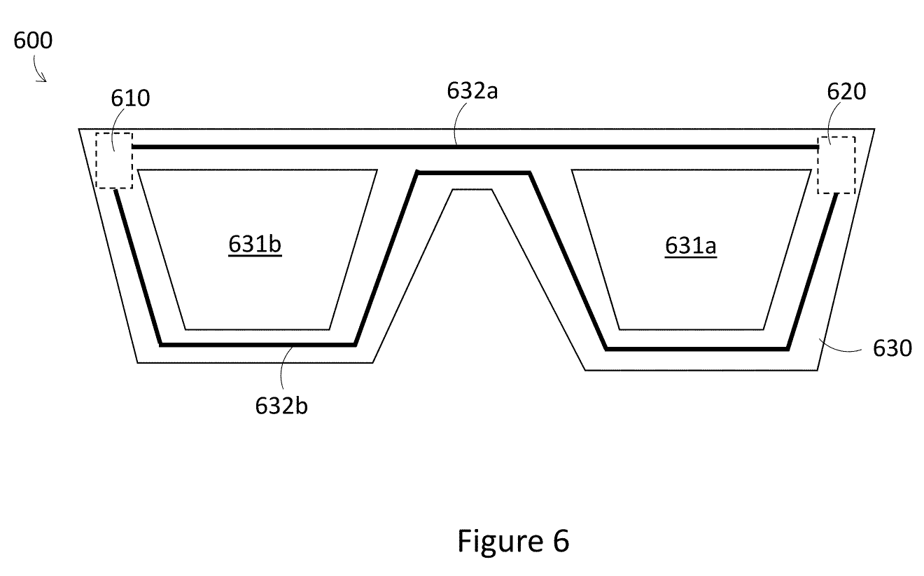

FIG. 6 is a front view of a WHUD 600 in accordance with an exemplary implementation. WHUD 600 is similar in at least some respects to WHUD 500 illustrated in FIG. 5. FIG. 6 illustrates exemplary paths which connectors can take through front frame 630. For example, connector 632a connects a battery in second arm 620 to electrical components in a first arm 610, and connector 632a runs along the top of front frame 630, above at least one lens or optical combiner 631a, 631b. As another example, connector 632b connects a battery in second arm 620 to electrical components in a first arm 610, and connector 632b runs along the bottom of the front frame 630, below at least one lens or optical combiner 631a, 631b. One skilled in the art will appreciate that connector 632a may be used alone to electrically couple the battery in second arm 620 to electrical components in first arm 610. One skilled in the art will also appreciate that connector 632b may be used alone to electrically couple the battery in second arm 620 to electrical components in first arm 610. One skilled in the art will also appreciate that both connector 632a and connector 632b may be used together to electrically couple the battery in second arm 620 to electrical components in first arm 610. One skilled in the art will also appreciate that each of connectors 632a and 632b can comprise a plurality of connectors, such as multiple wires, ribbon cables, or wiring harnesses for example.

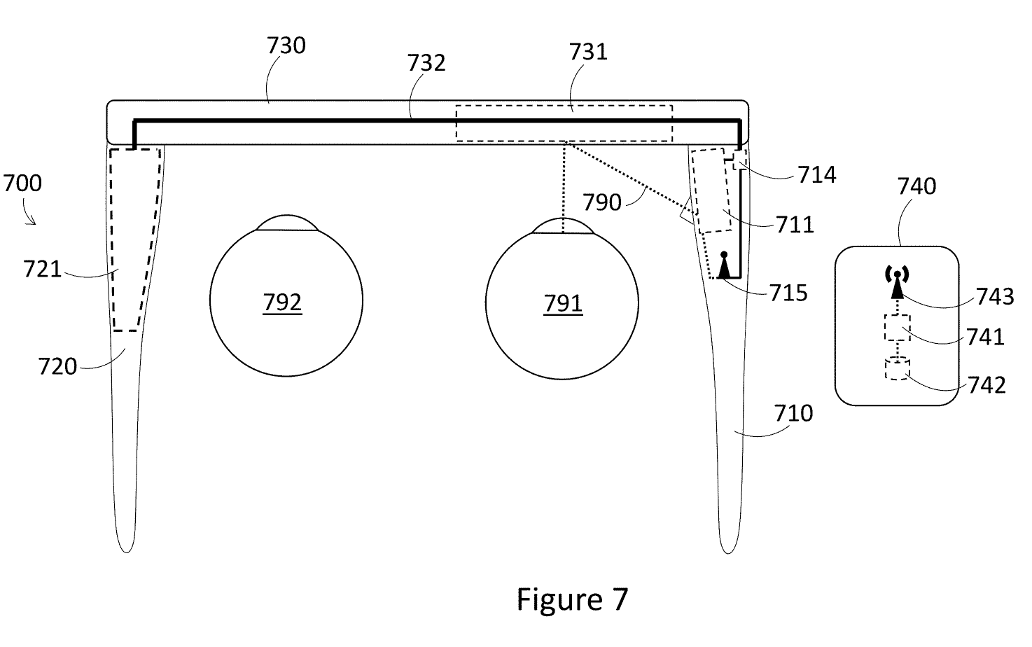

FIG. 7 is a top view of a WHUD 700 positioned relative to a pair of eyes 791, 792 in accordance with an exemplary implementation. WHUD 700 is similar in at least some respects to WHUD 200 illustrated in FIG. 2, and much of the description regarding FIG. 2 is applicable to FIG. 7. Specifically, the following table illustrates elements of FIG. 2 which may be similar or even identical to elements of FIG. 7:

| Element in FIG. 2 | Element in FIG. 7 |
|---|---|
| First arm 210 | First arm 710 |
| Light engine 211 | Light engine 711 |
| Power supply circuit 214 | Power supply circuit 714 |
| Second arm 220 | Second arm 720 |
| Battery 221 | Battery 721 |
| Front frame 230 | Front frame 730 |
| Optical combiner 231 | Optical combiner 731 |
| Connector 232 | Connector 732 |
| Output light 290 | Output light 790 |
| User eye 291 | User eye 791 |

One skilled in the art will appreciate that the description relating to each element in either Figure is applicable to the corresponding element in the other Figure.

One difference between FIGS. 2 and 7 is the inclusion of peripheral device 740 which can be used to execute processing, to reduce the processing burden of WHUD 700. Peripheral device includes at least one processor 741, a non-transitory processor-readable medium 742, and wireless transmitter 743. Non-transitory processor-readable medium 742 and wireless transmitter 743 are communicatively coupled to the at least one processor 741. The descriptions related to FIG. 2 regarding at least one processor 212 are applicable to at least one processor 741 in FIG. 7, with the exception that at least one processor 741 is carried by peripheral device 740 instead of a WHUD. Similarly, the descriptions related to FIG. 2 regarding non-transitory processor-readable medium 213 are applicable to non-transitory processor-readable medium 742 in FIG. 7, with the exception that non-transitory processor-readable medium 742 is carried by peripheral device 740 instead of a WHUD. Peripheral device 740 can be any type of appropriate device capable of processing, such as a smartphone, a PDA, a tablet, a laptop, a smartwatch, a desktop computer, or any other device as appropriate for a given application. Peripheral device 740 can even be a dedicated processing pack, which simply carries processing components for use with WHUD 700. Non-transitory processor-readable medium 742 carries processor-executable instructions which can be executed by the at least one processor 741, and the results of the executed instructions can be transmitted by wireless transmitter 743. Exemplary systems in which at least some hardware can be carried by a peripheral device instead of a WHUD are described in U.S. Provisional Patent Application Ser. No. 61/989,848 (now U.S. Non-Provisional patent application Ser. No. 14/704,663).

The results of the executed instructions can be received by wireless receiver 715 carried by WHUD 700. Wireless receiver 715 is communicatively coupled to at least light engine 711. In this way, display data can be processed by at least one processor 741, sent to WHUD 700 via wireless transmitter 743 and wireless receiver 715, and displayed using light engine 711. In summary, processing of data can be off-boarded from the WHUD 700 to the peripheral device 740. This can reduce the quantity and size of the processing components used in WHUD 700, and can also reduce the power consumed by WHUD 700, allowing for a smaller battery to be used. Consequently, the implementation shown in FIG. 7 can significantly reduce the weight and bulk of a wearable heads-up display, improving comfort and visual appeal for users.

One skilled in the art will appreciate that even though FIG. 7 only illustrates at least one processor carried by the peripheral device 740, it is still possible for WHUD 700 to also carry at least one processor. This will allow for WHUD 700 to perform some processing, while also allowing some processing to be off-boarded to the peripheral device 740, thus improving flexibility of the system.

One skilled in the art will also appreciate that even though wireless receiver 715 is illustrated as being carried in the first arm 710 of WHUD 700, wireless receiver 715 could be carried in any appropriate configuration on WHUD 700. For example, since there can be advantages to having a wireless receiver occupy a large space (such as for example with a TV antenna), wireless receiver 715 may extend beyond first arm 710, or may be carried by a different portion of WHUD 700 entirely. In one illustrative implementation, wireless receiver 715 may comprise a length of wire which runs along at least a portion of front frame 730, such that wireless receiver 715 acts as a more effective antenna.

One skilled in the art will also appreciate that even though FIG. 7 illustrates that peripheral device 740 communicates with WHUD 700 wirelessly via wireless transmitter 743 and wireless receiver 715, peripheral device 740 could also be wired to WHUD 700. Processing results from the at least one processor 741 could be sent to WHUD 700 via the wired connection. Further, peripheral device may carry a battery which powers components of WHUD 700 via the wired connection. Such a battery carried by peripheral device 740 could be supplemental to battery 721 carried by WHUD 700, or could replace battery 721 completely.

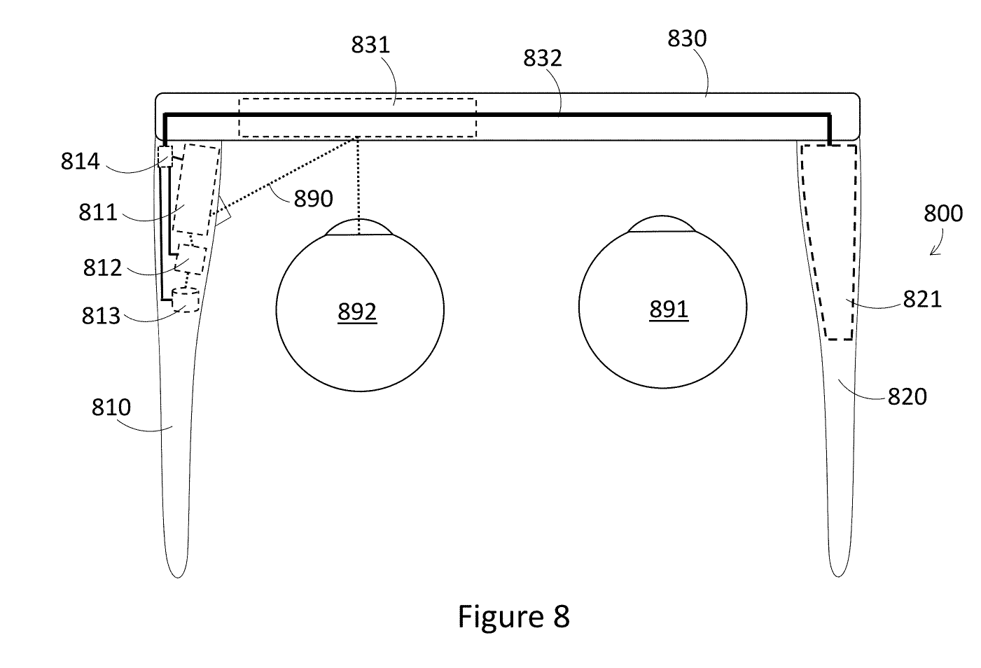

FIG. 8 is a top view of a WHUD 800 positioned relative to a pair of eyes 891, 892 in accordance with an exemplary implementation. WHUD 800 is similar in at least some respects to WHUD 200 illustrated in FIG. 2, and much of the description regarding FIG. 2 is applicable to FIG. 8. Specifically, the following table illustrates elements of FIG. 2 which may be similar or even identical to elements of FIG. 8:

| Element in FIG. 2 | Element in FIG. 8 |
|---|---|
| First arm 210 | First arm 810 |
| Light engine 211 | Light engine 811 |
| At least one processor 212 | At least one processor 812 |
| Non-transitory processor-readable | Non-transitory processor-readable |
| medium 213 | medium 813 |
| Power supply circuit 214 | Power supply circuit 814 |
| Second arm 220 | Second arm 820 |
| Battery 221 | Battery 821 |
| Front frame 230 | Front frame 830 |
| Optical combiner 231 | Optical combiner 831 |
| Connector 232 | Connector 832 |
| Output light 290 | Output light 890 |

One skilled in the art will appreciate that the description relating to each element in either Figure is applicable to the corresponding element in the other Figure.

One difference between FIGS. 2 and 8 is that the orientation of WHUD 800 has been flipped compared to that of WHUD 200. That is, in FIG. 2, first arm 210 is illustrated as being positioned on a right side of a user's head, second arm 220 is illustrated as being positioned on a left side of a user's head, and optical combiner 231 is illustrated as being positioned in a right-side portion of front frame 230, such that light engine 211 will output light 290 which is redirected by optical combiner 231 towards a right eye of the user 291. In contrast, in WHUD 800 as shown in FIG. 8, first arm 810 is positioned on a left side of a user's head, second arm 820 is positioned on a right side of a user's head, and optical combiner 831 is positioned in a left-side portion of front frame 830, such that light engine 811 will output light 890 which is redirected by optical combiner 831 towards a left eye of the user 892. By flipping the orientation of the WHUD, the WHUD can be usable by users who have poor vision or no vision in their right eye. Additionally, flipping the orientation of the WHUD creates an additional option for users who simply prefer to have a display for their left eye instead of their right eye. One skilled in the art will appreciate that this concept of flipping the orientation of the WHUD can be applied in any of the other implementations described herein.

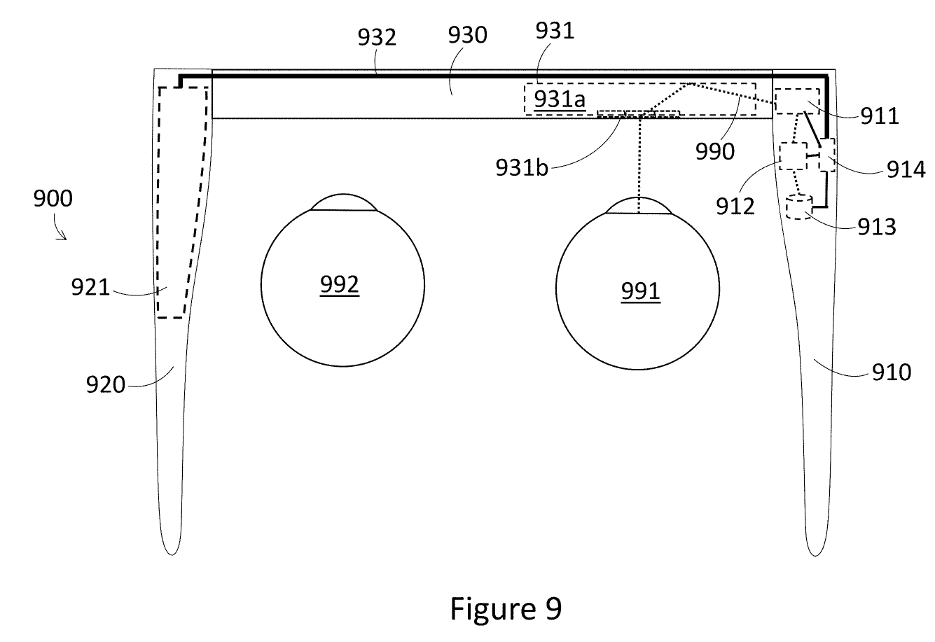

FIG. 9 is a top view of a WHUD 900 positioned relative to a pair of eyes 991, 992 in accordance with an exemplary implementation. WHUD 900 is similar to WHUD 200 illustrated in FIG. 2, and much of the description regarding FIG. 2 is applicable to FIG. 9. Specifically, the following table illustrates elements of FIG. 2 which may be similar or even identical to elements of FIG. 9:

| Element in FIG. 2 | Element in FIG. 8 |
|---|---|
| At least one processor 212 | At least one processor 912 |
| Non-transitory processor-readable | Non-transitory processor-readable |
| medium 213 | medium 913 |
| Power supply circuit 214 | Power supply circuit 914 |
| Battery 221 | Battery 921 |
| Connector 232 | Connector 932 |

One skilled in the art will appreciate that the description relating to each element in either Figure is applicable to the corresponding element in the other Figure.

One difference between FIGS. 2 and 9 relates to the display architecture. Particularly, in the implementation of FIG. 9, optical combiner 931 comprises a lightguide 931a and at least one light out-coupler 931b. Light engine 911 outputs light 990 representative of display content to be viewed by a user, and light engine 911 outputs this output light 990 into lightguide 931a via a periphery of the optical combiner 931. Output light 990 is then guided by lightguide 931a, for example by total internal reflection, until output light 990 impinges on the at least one out-coupler 931b. The at least one out-coupler 931b then redirects output light 990 towards an eye of user 991, such that the user can see the display content represented by the output light 990. This display architecture causes the light engine 911 to be closer to the front of WHUD 900 than the light engine 211 of WHUD 200.

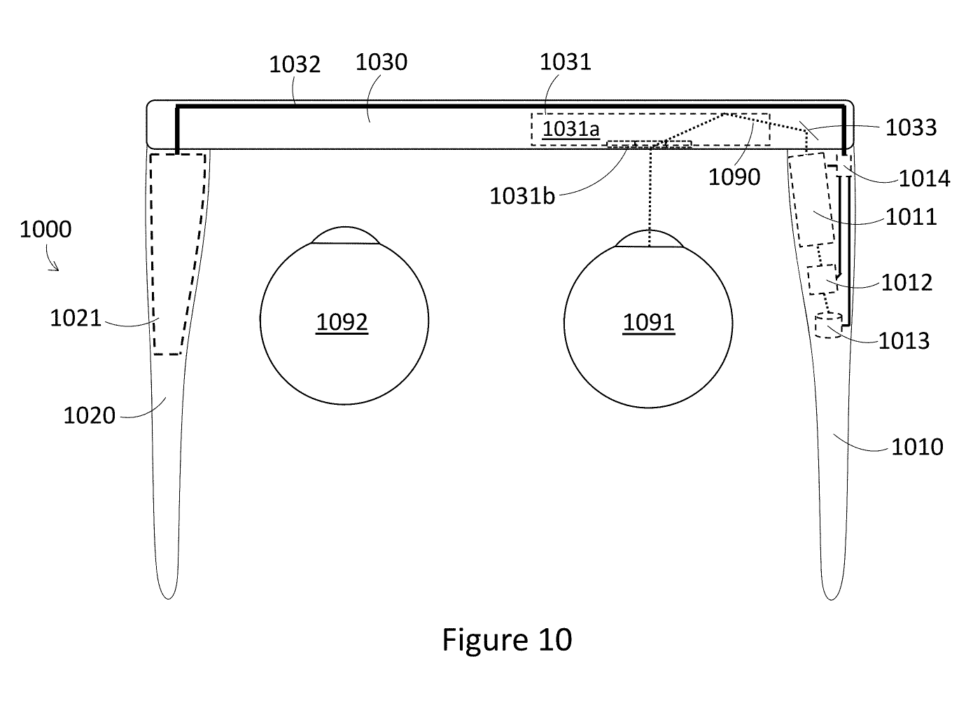

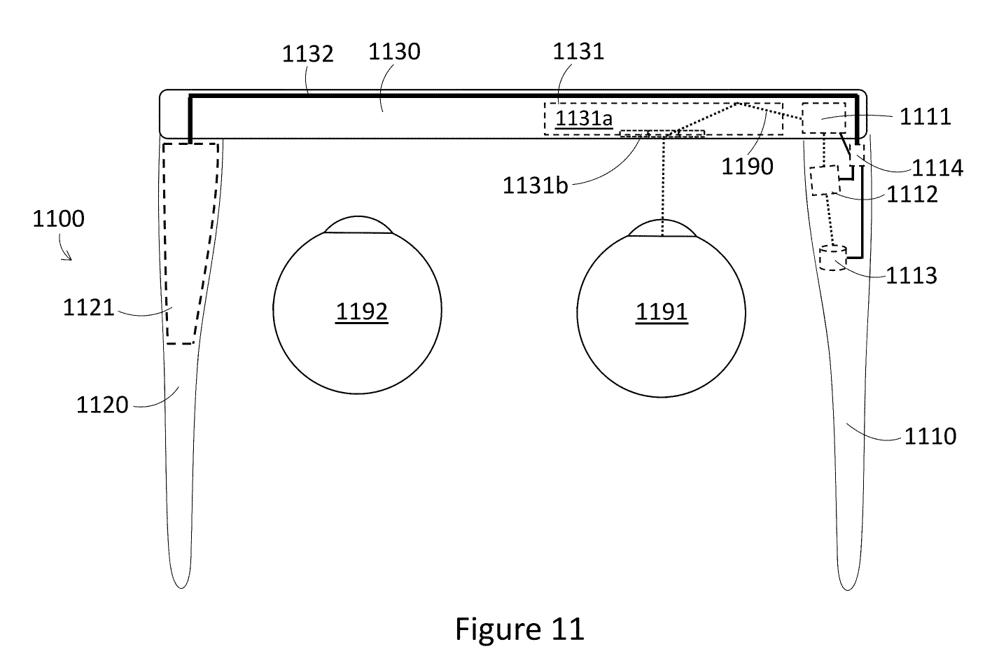

In the implementation illustrated in FIG. 9, first arm 910 is shown as extending all the way from the back of WHUD 900 to the front of WHUD 900, with the front frame 930 butted up against first arm 910. Consequently, even though light engine 911 is disposed near the front of WHUD 900 at the periphery of optical combiner 931, light engine 911 is still carried by first arm 910. In the interests of symmetry and balance, FIG. 9 also shows second arm 920 as extending all the way from the back of WHUD 900 to the front of WHUD 900, with front frame 930 butted up against second arm 920. Battery 921 can consequently be positioned close to the front of WHUD 900. However, one skilled in the art will appreciate that the above described display architecture can be achieved even if the first arm and second arm do not extend all the way to the front of the WHUD. FIGS. 10 and 11 illustrate alternative structures in this regard.

FIG. 10 is a top view of a WHUD 1000 positioned relative to a pair of eyes 1091, 1092 in accordance with an exemplary implementation. WHUD 1000 is similar in at least some respects to WHUD 900 illustrated in FIG. 9, and much of the description regarding FIG. 9 is applicable to FIG. 10. Consequently, much of the description of FIG. 2 is also applicable to FIG. 10. The following table illustrates elements of FIG. 9 which may be similar or even identical to elements of FIG. 10:

| Element in FIG. 9 | Element in FIG. 10 |
|---|---|
| At least one processor 912 | At least one processor 1012 |
| Non-transitory processor-readable | Non-transitory processor-readable |
| medium 913 | medium 1013 |
| Power supply circuit 914 | Power supply circuit 1014 |
| Optical combiner 931 | Optical combiner 1031 |
| Lightguide 931a | Lightguide 1031a |
| At least one out-coupler 931b | At least one out-coupler 1031b |
| Connector 932 | Connector 1032 |
| User eye 991 | User eye 1091 |

One skilled in the art will appreciate that the description relating to each element in either Figure is applicable to the corresponding element in the other Figure.

One difference between FIGS. 9 and 10 is the structure of the arms and front frame. In particular, in FIG. 10, first arm 1010 and second arm 1020 do not extend all the way to the front of WHUD 1000, but instead butt up against front frame 1030. Front frame 1030 extends all the way from a left side of WHUD 1000 to a right side of WHUD 1000. Light engine 1011 is carried by first arm 1010, but since first arm 1010 does not extend all the way to the front of WHUD 1000, light engine 1011 cannot be positioned at the periphery of optical combiner 1031 to output light into the optical combiner. A light redirector 1033 can be carried by front frame 1030 at the periphery of optical combiner 1031, such that light redirector 1033 reflects output light 1090 from light engine 1011 into a periphery of optical combiner 1031. Light redirector 1033 can comprise for example a reflector, a static mirror, a dynamic mirror such as a controllable scan mirror, a refractor, a prism, or any other light redirector as appropriate for a given application.

FIG. 11 is a top view of a WHUD 1100 positioned relative to a pair of eyes 1191, 1192 in accordance with an exemplary implementation. WHUD 1100 is similar in at least some respects to WHUD 1000 illustrated in FIG. 10, and much of the description regarding FIG. 10 is applicable to FIG. 11. Consequently, much of the description of FIGS. 2 and 9 are also applicable to FIG. 11. The following table illustrates elements of FIG. 10 which may be similar or even identical to elements of FIG. 11:

| Element in FIG. 10 | Element in FIG. 11 |
|---|---|
| First arm 1110 | First arm 1110 |
| At least one processor 1112 | At least one processor 1112 |
| Non-transitory processor-readable | Non-transitory processor-readable |
| medium 1113 | medium 1113 |
| Power supply circuit 1114 | Power supply circuit 1114 |
| Second arm 1120 | Second arm 1120 |
| Battery 1121 | Battery 1121 |
| Front frame 1130 | Front frame 1130 |
| Optical combiner 1131 | Optical combiner 1131 |
| Lightguide 1031a | Lightguide 1131a |
| At least one out-coupler 1031b | At least one out-coupler 1131b |
| Connector 1132 | Connector 1132 |
| User eye 1091 | User eye 1191 |

One skilled in the art will appreciate that the description relating to each element in either Figure is applicable to the corresponding element in the other Figure.

One difference between FIGS. 10 and 11 is the positioning of light engine 1111. In particular, in FIG. 11, first arm 1110 and second arm 1120 do not extend all the way to the front of WHUD 1100, but instead butt up against front frame 1130. Front frame 1130 extends all the way from a left side of WHUD 1100 to a right side of WHUD 1100. In contrast to FIG. 10, in FIG. 11 light engine 1111 is carried by front frame 1130, such that light engine 1111 can output light 1190 directly into a periphery of optical combiner 1131 without the need for an intervening reflector.

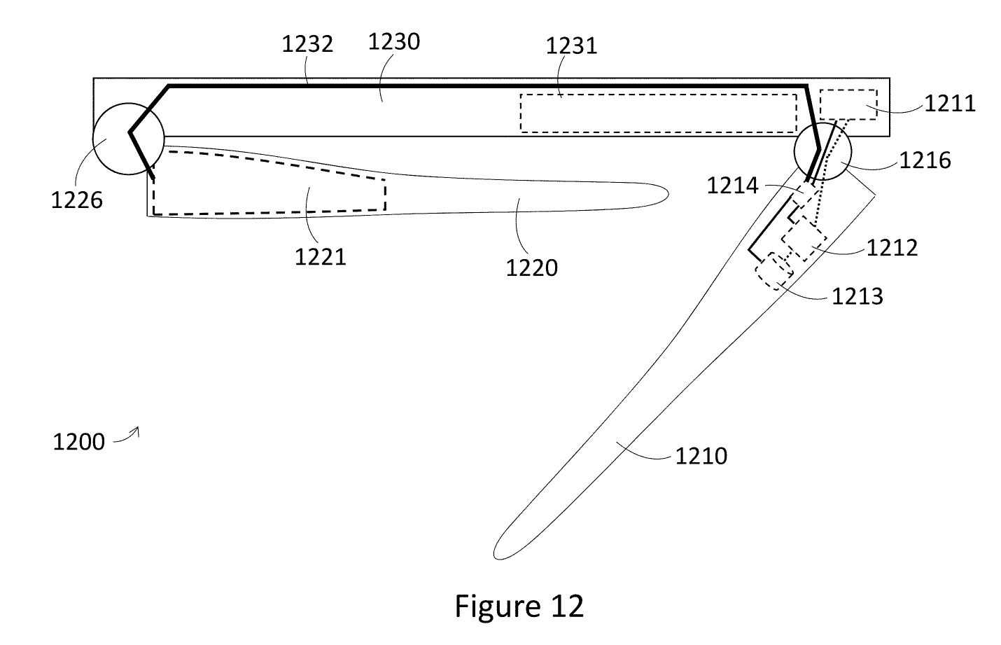

In many of the above implementations, each first arm and second arm can simply be directly physically coupled to a respective front frame. For example, a given first arm and second arm could be coupled to a respective front frame using built in clips, hooks, grooves, nubs, protrusions, depressions, interlocks, or any other appropriate mechanism for coupling the first arm and the second arm to the front frame. Alternatively, a given first and a given second arm can be coupled to a respective front frame using fasteners, such as glue, screws, bolts, pins, or any other appropriate fastener. As a further alternative, a given first arm, second arm, and front frame could be formed as a single piece, such that the distinct between the first arm, the second arm, and the front frame is a conceptual distinction. Alternatively, a given first arm and a given second arm can be indirectly coupled to a respective front frame by at least one intermediary coupler, as is exemplified in FIG. 12. FIG. 12 is a top view of a WHUD 1200 which is similar to WHUD 1100 illustrated in FIG. 11, such that much of the description regarding FIG. 11 is applicable to FIG. 12. Consequently, much of the description of FIGS. 2, 9, and 10 are also applicable to FIG. 12. The following table illustrates elements of FIG. 11 which may be similar or even identical to elements of FIG. 12:

| Element in FIG. 11 | Element in FIG. 12 |
|---|---|
| First arm 1110 | First arm 1210 |
| Light engine 1111 | Light engine 1211 |
| At least one processor 1112 | At least one processor 1212 |
| Non-transitory processor-readable | Non-transitory processor-readable |
| medium 1113 | medium 1213 |
| Power supply circuit 1114 | Power supply circuit 1214 |
| Second arm 1120 | Second arm 1220 |
| Battery 1121 | Battery 1221 |
| Front frame 1130 | Front frame 1230 |
| Optical combiner 1131 | Optical combiner 1231 |
| Connector 1132 | Connector 1232 |

One skilled in the art will appreciate that the description relating to each element in either Figure is applicable to the corresponding element in the other Figure. Additionally, to avoid obscuring the features shown in FIG. 12, certain elements are not shown, such as eyes of a user and a path of output light. One skilled in the art will appreciate that the path of the output light to the user's eye is described in several other implementations herein, and that the elements of FIG. 12 can achieve similar or the same functionality.

One difference between FIGS. 11 and 12 is that FIG. 12 details a specific implementation for how first arm 1210 and second arm 1220 are coupled to front frame 1230. In particular, FIG. 12 illustrates an exemplary intermediary coupler 1216, which physically couples first arm 1210 to front frame 1230. Similarly, FIG. 12 illustrates another exemplary intermediary coupler 1226 which physically couples second arm 1220 to front frame 1230. Intermediary coupler 1216 and intermediary coupler 1226 can for example be hinges, such that first arm 1210 and second arm 1220 can rotate with respect to front frame 1230, as illustrated in FIG. 12. Intermediary coupler 1216 and intermediary coupler 1226 can have passages therethrough to allow connector 1232 to pass through, such that connector 1232 can electrically couple battery 1221 in second arm 1220 to electrical components in first arm 1210. Passages through the intermediary couplers can also allow for other connectors to pass through, such as to allow at least one processor 1212 carried in first arm 1210 to be communicatively coupled to light engine 1211 carried by front frame 1230, or to allow power supply circuit 1214 carried in first arm 1210 to provide power to light engine 1211 carried by front frame 1230, as illustrated in FIG. 12, for example. As an alternative, instead of the intermediary connectors including passages for connectors to run through, each of the intermediary couplers could instead have brush connectors built therein, which act as electrical connectors when the first arm 1210 and the second arm 1220 are in an extended position in which WHUD 1200 can be worn by a user.

One skilled in the art will appreciate that even though FIG. 12 illustrates an implementation which utilizes a display architecture where light engine 1211 is positioned at a periphery of optical combiner 1231, the intermediary couplers detailed in FIG. 12 and the corresponding description are applicable to any of the implementations and display architectures described herein, as well as any application in which any other suitable display architecture is utilized. To point out a specific example, intermediary couplers 1216 and 1226 could also be implemented in a WHUD such as WHUD 200 in FIG. 2, which utilizes a different display architecture.

One skilled in the art will appreciate that intermediary couplers as discussed herein are not restricted to hinges, but can include any appropriate construction which can couple the first arm and second arm to the front frame.

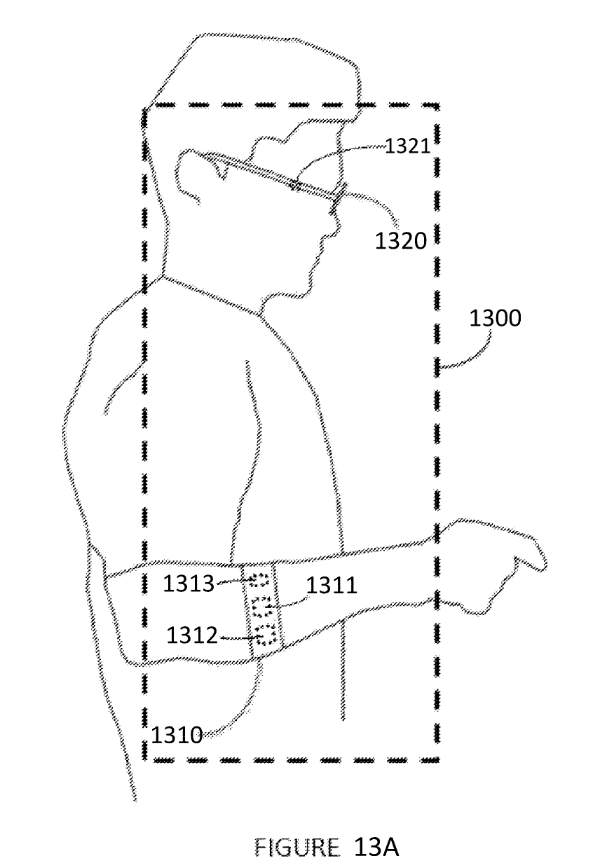

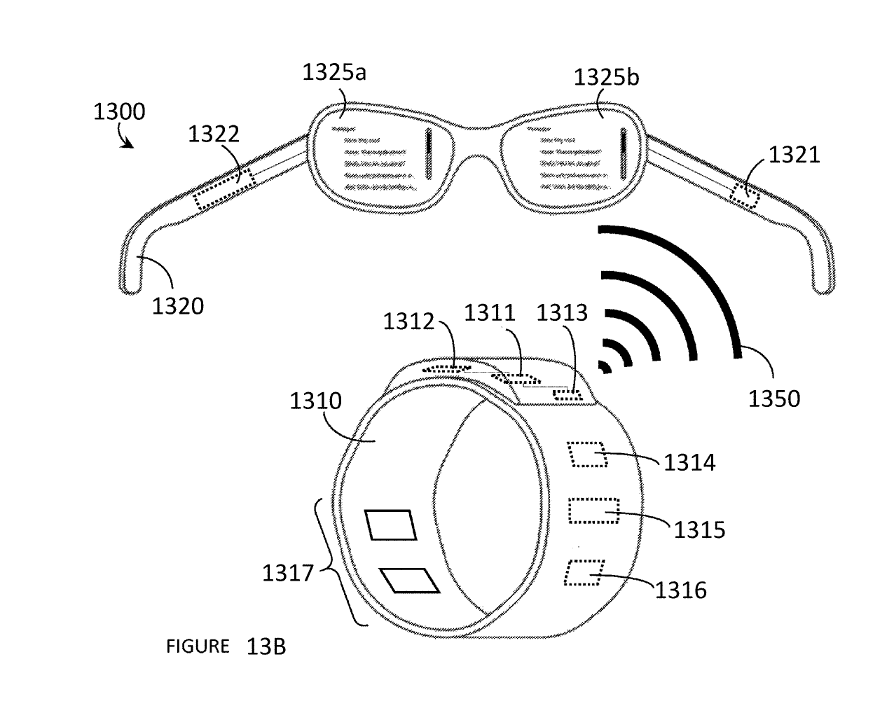

FIG. 13A is an illustrative diagram of a wearable computer system 1300 that includes a wearable electronic band 1310 wirelessly communicatively coupled to a peripheral wearable heads-up display (“WHUD”) 1320 in accordance with the present systems, devices, and methods. In use, band 1310 is worn on a limb of the user. In the illustrated example, band 1310 is an armband that is worn on an arm of the user, but in alternative implementations band 1310 may be worn elsewhere on the body of the user, such as on the user's wrist, finger, or leg, or alternatively band 1310 may include or be coupled to a belt worn around the user's waist. In use, peripheral WHUD 1320 is worn on the head of the user. Band 1310 and peripheral WHUD 1320 are, in the illustrated example of FIG. 13A, discrete, physically separate components of wearable computer system 1300, though in alternative implementations at least one physical connection (such as a structural coupling and/or a physical wire connection) may exist between band 1310 and peripheral WHUD 1320.

Band 1310 carries the main computational elements of wearable computer system 1300. Specifically, band 1300 carries at least a computer processor 1311, a non-transitory processor-readable storage medium or memory 1312 that is communicatively coupled to processor 1311, and a wireless transmitter 1313 that is communicatively coupled to processor 1311. Processor 1311 may be any type of processor, including but not limited to: a digital microprocessor or microcontroller, an application-specific integrated circuit (ASIC), a field-programmable gate array (FPGA), a digital signal processor (DSP), a graphics processing unit (GPU), a programmable gate array (PGA), a programmable logic unit (PLU), or the like. Memory 1312 stores at least processor-executable display instructions that, when executed by processor 1311, cause band 1310 to define display data (i.e., by processor 1311) and wirelessly transmit the display data (i.e., by transmitter 1313).

Peripheral WHUD 1320 is communicatively coupled to band 1310 and, in use, displays content to the user in a manner similar to a typical computer monitor. Peripheral WHUD 1320 includes a wireless receiver 1321 to receive the display data wirelessly transmitted from band 1310 (i.e., by transmitter 1313) and at least a first display element (not called out in FIG. 13A) communicatively coupled to receiver 1321. In response to wirelessly receiving the display data from band 1310, peripheral WHUD 1320 operates the at least a first display element to display information to the user. Further details of wearable computer system 1300 are apparent in the alternate view of FIG. 13B in which the components of wearable computer system 1300 are depicted off of the body of the user.

FIG. 13B is an alternate illustrative view of wearable computer system 1300 from FIG. 13A. The view of FIG. 13A illustrates an example of how the elements of wearable computer system 1300 may be worn on the body of a user while in use. In the alternate view of FIG. 13B, the components of wearable computer system 1300 are depicted off of the body of the user and re-oriented to reveal additional features.

FIG. 13B shows that band 1310 includes further elements in addition to processor 1311, memory 1312, and transmitter 1313. For example, FIG. 13B shows that band 1310 includes: a wireless transceiver 1314 to provide wireless Internet connectivity for wearable computer system 1300; a first sensor 1315 that is responsive to (i.e., detects, senses, measures, or transduces) at least one input from the user and/or from the user's environment; a first discrete power source 1316 (e.g., a first battery); and at least a second sensor 1317 that is responsive to (i.e., detects, senses, measures, or transduces) at least one input from the user. Either or both of first sensor 1315 and second sensor 1317 may include any or all of, for example: an accelerometer, a gyroscope, a global positioning system (“GPS”) sensor, a compass, an electromyography (“EMG”) sensor, a mechanomyography (“MMG”) sensor, an electrocardiography (“ECG”) sensor, and/or a blood pressure sensor. Any and/or all of sensors 1315 and 1317 may be used to modify, control, or interact with information that is displayed to the user by peripheral WHUD 1320 in response to detected inputs from the user and/or from the user's environment. In the illustrated example of FIG. 13B, each of first sensor 1315 and second sensor 1317 includes a respective EMG sensor responsive to muscle activity of the user when the user performs one or more physical gesture(s).

FIG. 13B also shows that peripheral WHUD 1320 includes further elements in addition to wireless receiver 1321. For example, FIG. 13B shows that peripheral WHUD 1320 includes: a first display element 1325a that is positioned within a field of view of a first eye of a user when peripheral WHUD 1320 is worn on the user's head; a second display element 1325b that is positioned within a field of view of a second eye of the user when peripheral WHUD 1320 is worn on the user's head; and a second discrete power source 1322 (e.g., a second battery). In accordance with the present systems, devices, and methods, peripheral WHUD 1320 has a general shape and appearance of a set of eyeglasses, which is facilitated by the fact that peripheral WHUD 1320 does not include many computational elements (e.g., processor 1311 and memory 1312) that are typically included in/on other heads-up displays available today. In wearable computer system 1300, the majority (and in some implementations, all) of the computational processing tasks are completed on-board band 1310 as opposed to on-board peripheral WHUD 1320 and, as a result of such computational processing, display data is wirelessly transmitted from band 1310 to peripheral WHUD 1320 to be displayed to the user.

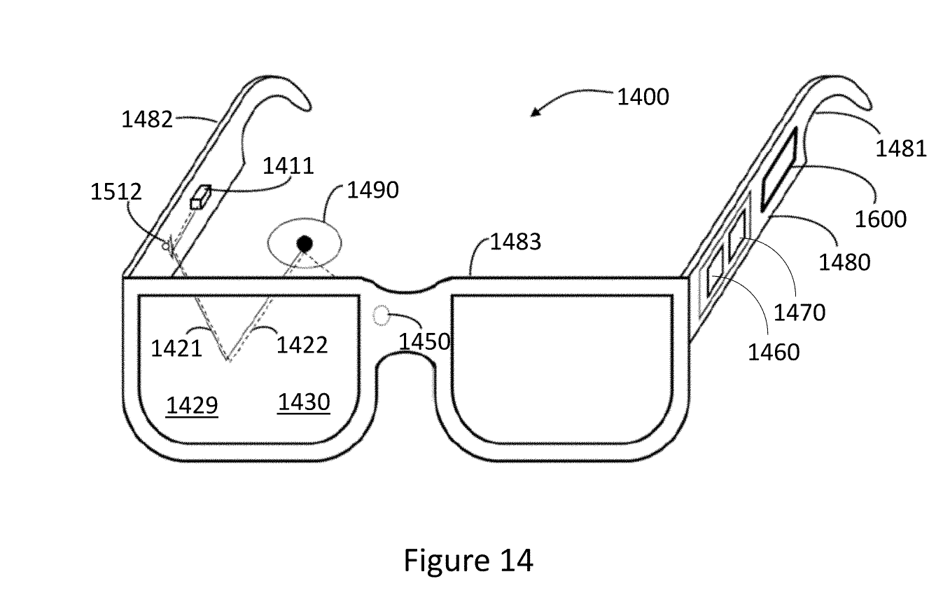

Turning now to FIG. 14, illustrated therein is a perspective view of an exemplary WHUD 1400 operable for wireless communication with electronic devices. WHUD as shown includes elements such as a projector 1411 (i.e., a laser module) adapted to output a visible laser light 1421 (e.g., in at least a first narrow waveband). In some cases, the projector 1411 may be operable to output infrared laser light 1422. The WHUD 1400 also includes a display component that enables the user to see displayed content but also does not prevent the user from being able to see their external environment. As shown, the display component could include a transparent combiner 1430 (aligned with an eyeglass lens 1429) which redirects the laser light 1421 and 1422 towards an eye 1490 of a user. In some embodiments, the WHUD 1400 may include at least one infrared photodetector 1450 responsive to infrared laser light 1422.

Depending on the implementation, the visible laser light 1421 may correspond to any of, either alone or in any combination, red laser light, a green laser light, and/or a blue laser light.

WHUD 1400 also includes a support frame 1480 that has a general shape and appearance of a pair of eyeglasses, so that transparent combiner 1430 is positioned within a field of view of an eye 1490 of the user when support frame 1480 is worn on a head of the user. The support frame 1480 typically includes two support arms 1481, 1482 extending rearwardly from a front rim portion 1483 that supports the eyeglass lens 1429 and transparent combiner 1430. The rim portion 1483 is normally supported by a nose of the user, while the support arms 1481, 1482 are normally supported by the ears of the user.

WHUD 1400 further includes a digital processor 1460 communicatively coupled to photodetector 1450 (in this example), and a non-transitory processor-readable storage medium or memory 1470 communicatively coupled to digital processor 1460. Memory 1470 stores processor-executable instructions and/or data that, when executed by processor 1460, can cause processor 1460 to take actions, such as determining one or more position(s) and/or movement(s) of eye 1490, determining what information to display on the transparent combiner 1430, and managing communication between the WHUD 1400 and one or more electronic devices.

In particular, WHUD 1400 further includes a communication module 1600 for wireless communication with other electronic devices, and which may be communicatively coupled to the digital processor. Generally speaking, according to the teachings herein, one or more components of the communication module 1600 may be integrated within one or more components of the support frame 1480. For instance, the communication module 1600 may be at least partially integrated within one or both of the support arms 1481, 1482. The communication module 1600 may be at least partially integrated within the rim portion 1483 of the support frame 1480. In some examples, the communication module 1600 may be at least partially integrated within some combination of the support arms 1481, 1482 and the rim portion 1483.

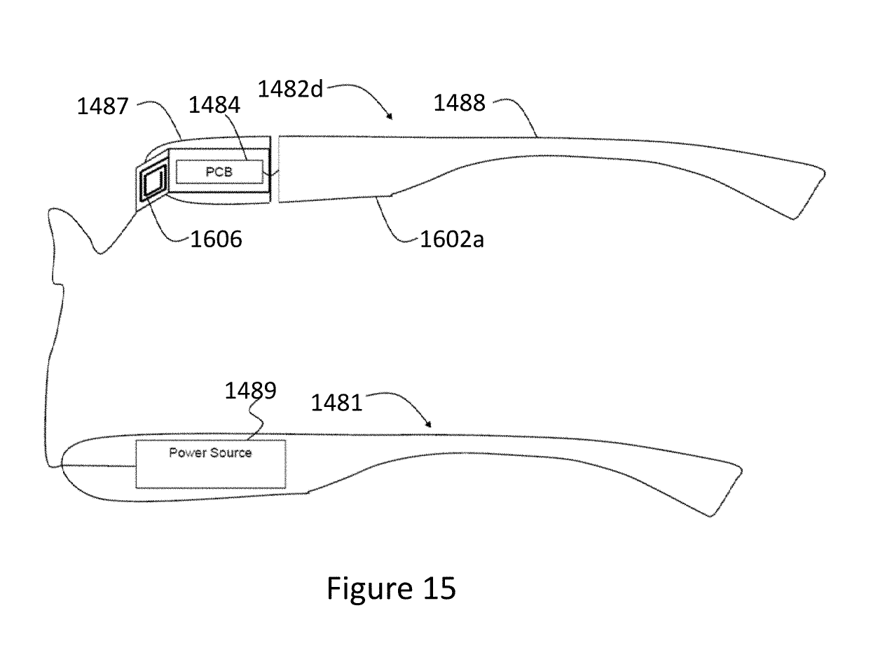

In an exemplary implementation illustrated in FIG. 15, arm support 1482d includes a first forward portion 1487, and a second rearward portion 1488. The forward portion 1487 may be positioned adjacent (or even be part of) the rim support 1483, and may include PCB 1484. As shown, the forward portion 1487 includes an antenna 1606 (shown here as a spiral antenna). The forward portion 1487 can generally have a consistent shape and size, regardless of the sizing required to accommodate a particular head of a user.

The rearward portion 1488 of the arm support 1482d, on the other hand, can have a size and shape that is selected to accommodate the sizing requirements for the user's head. For instance, in larger WHUDs 1400, the rearward portion 1488 could be longer, while in smaller WHUDs the rearward portion 1488 could be smaller.

In some embodiments, the rearward portion 1488 could include a body member 1602a (i.e., a metal plate), which could be used to extend the ground plane.

As shown in FIG. 15, in this implementation the other arm support 1481 could support a power source 1489 (i.e., a battery) which provides power to the components in the arm support 1482d.

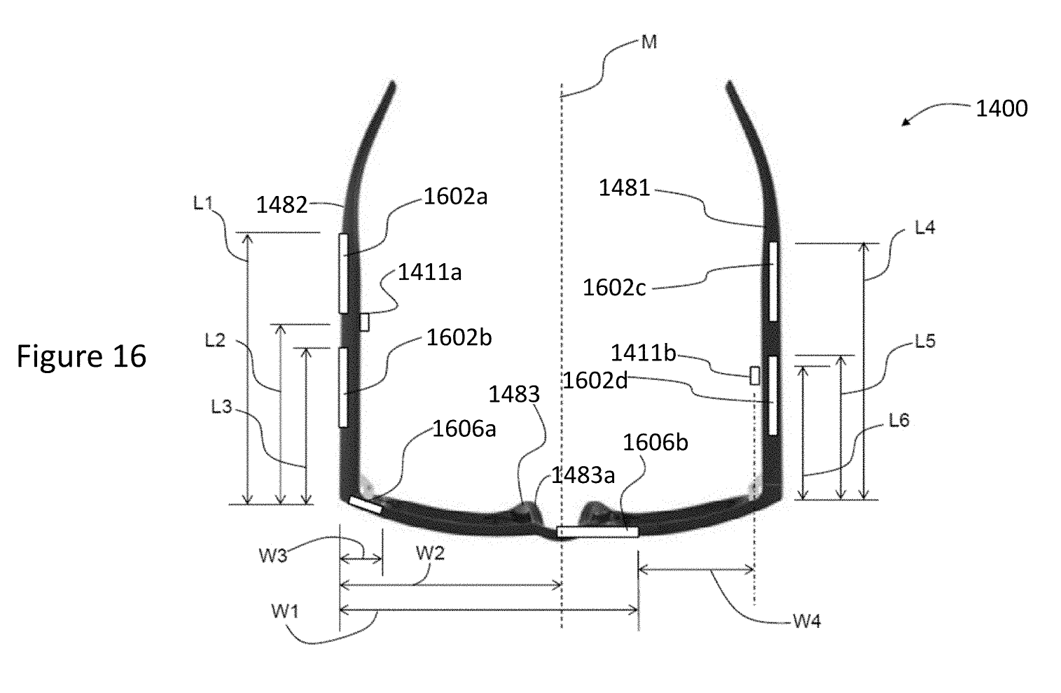

Turning now to FIG. 16, shown therein is a top plan view of a WHUD 1400 according to yet another exemplary embodiment. This schematic shows various possible relative positions between components of the communication module 1600 and the projector 1411. For example, a first exemplary projector 1411a is shown mounted on arm support 1482, and is positioned at a distance L2 from a front right corner of the WHUD 1400. One or more body portions are positioned along the arm support 1482, such as body portion 1602a positioned generally rearwardly of the projector 1411a (at a distance L1) and body portion 1602b positioned generally forwardly of the projector 1411a (at a distance L3). In some cases, one or both of the body portions 1602a, 1602b may serve as antenna elements for the communication module 1600. In some cases, one or both of the body portions 1602a, 1602b may serve as a grounding element for extending a ground plane. FIG. 16 also shows an antenna 1606a positioned forwardly of the projector 1411a, generally integral with the rim portion 1483, and having a width W3.

A second exemplary projector 1411b is shown mounted on arm support 1481, and is positioned at a distance L6 from a front left corner of the WHUD 1400. One or more body portions are positioned along the arm support 1481, such as body portion 1602c positioned generally rearwardly of the projector 1411b (at a distance L4) and body portion 1602d positioned generally in alignment with the projector 1411b (at a distance L5), with a segment extending rearwardly thereof and another segment extending forwardly thereof. In various embodiments, one or both of the body portions 1602c, 1602d may serve as antenna elements for the communication module 1600, or may serve as a grounding element for extending a ground plane thereof. FIG. 16 also shows a second antenna 1606b positioned forwardly of the projector 1411b, generally integral with the rim portion 1483, and at least partially aligned with a midline M of the WHUD 1400. The second antenna 1606b is positioned at a distance W1 from the front right corner of the WHUD 1400 and at a distance W4 from the front left corner of the WHUD 1400.

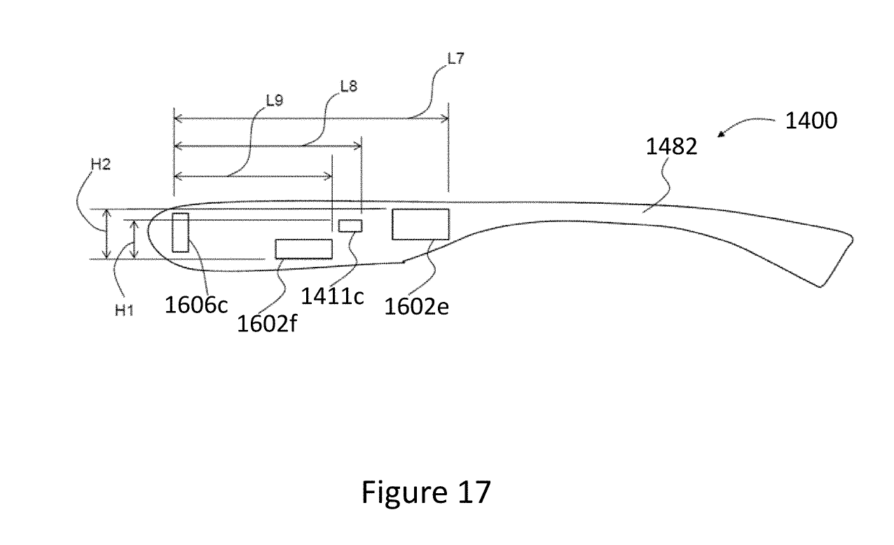

Turning now to FIG. 17, a side elevation view of a WHUD 1400 is shown according to yet another exemplary embodiment. In this embodiment, arm support 1482 has a body portion 1602e positioned rearwardly (at a distance L7 from the front of the arm portion 1482) of a projector 1411c (at a distance L8), and generally in vertical alignment (at height H2) with the projector 1411c (at height H1). Arm support 1482 also includes body portion 1602f positioned forwardly (at a distance L9) of the projector 1411c and below the projector 1411c. Also shown is an antenna 1606c positioned forwardly of the projector 1411c, generally in vertical alignment with the projector 1411c.

It will be understood that the various lengths L1-L9, widths W1-W4, and heights H1-H2 can be selected according to the size and shape of the WHUD 1400.

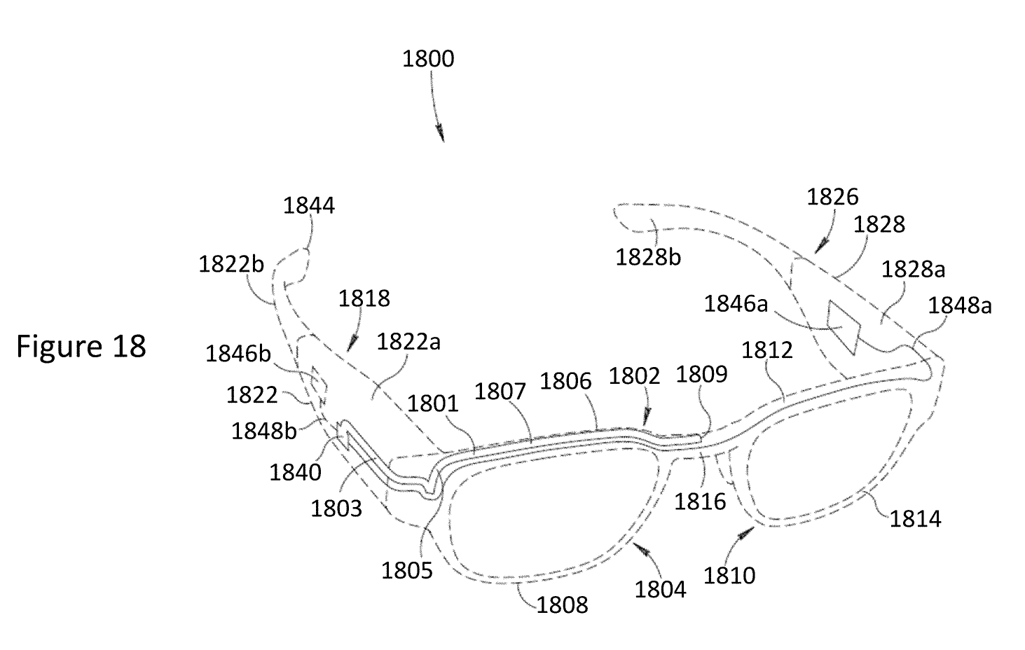

In addition, implementations of the present disclosure include an antenna, a power source, and an electrically conductive path or wire placed in various locations within a front frame of eyewear. For example, FIG. 18 is a perspective view of an exemplary implementation of eyeglasses 1800, having an antenna 1801 incorporated in the eyeglasses 1800. For ease of recognition in the drawings, eyeglasses 1800 are represented by dashed lines and certain internal features, such as the frame portions and apertures of arms 1818, 1826 are not shown, although one of skill in the art will appreciate that such features are present within implementations of the eyeglasses 1800.

The eyeglasses 1800 include first and second arms 1818 and 1826 coupled to a front eyeglass frame 1802. The front eyeglass frame 1802 includes a first rim 1804 and a second rim 1810 securely physically coupled by a bridge 1816. A radio 1840 is housed internally in a first temple portion 1822 of the first arm 1818, and preferably within a first anterior portion 1822a of the first temple portion 1822 of the first arm 1818. The radio 1840 is electrically coupled to, or in electrical communication with the antenna 1801, which passes internally through the eyeglasses 1800 and front eyeglass frames 1802 of the eyeglasses 1800 as discussed below.

The antenna 1801 extends from the radio 1840 at least proximate the first temple portion 1822 and the first frame portion (not shown) of the first arm 1818, through the first aperture (not shown) and along at least a portion of the first rim 1804. In an implementation, the antenna 1801 terminates at any location within the first rim 1804, while in the implementation illustrated in FIG. 18, the antenna 1801 extends from the radio 1840 in the first arm 1818 along a first upper peripheral portion 1806 of the first rim 1804 to terminate proximate the bridge 1816. In a further implementation, the antenna 1801 terminates in the bridge 1816, or in other words, a second distal end 1809 is a terminal end of antenna 1801 and is positioned internally within the bridge 1816 when the eyeglasses are in an operational or assembled state. In this configuration, a first portion 1803 of the antenna 1801 is housed at least partially in the first temple portion 1822 of the first arm 1818 and a second and third portion 1805 and 1807 of the antenna 1801 are housed at least partially in the first frame 1804, and more preferably within the first upper peripheral portion 1806 of the first frame 1804.

One of skill in the art will also appreciate that although not specifically shown, the antenna 1801 can extend beyond the bridge 1816 to terminate within the second rim 1810. For example, in an implementation, the antenna 1801 extends from the radio 1840, through the first upper peripheral portion 1806 of the first rim 1804, through the bridge 1816 to terminate within either a second upper peripheral portion 1812 or a second lower peripheral portion 1814 of the second rim 1810. One of skill in the art will also appreciate that the antenna 1801 can pass internally from the radio 1840, through the first aperture (not shown) of the first arm 1818 to at least a first lower peripheral portion 1808 of the first rim. In such an implementation, the antenna 1801 terminates within the first lower peripheral portion 1808, within the bridge 1816 as above, or beyond the bridge 1816 to a location within the second rim 1810. In implementations where the antenna 1801 passes through the first lower peripheral portion 1808 of the first rim 1804 and extends beyond the bridge 1816, the antenna 1801 can terminate within the second upper peripheral portion 1812 or the second lower peripheral portion 1814 of the second rim 1810. It is even possible, in an implementation, to extend the antenna from the first arm 1818, through the first rim 1804, the bridge 1816, and the second rim 1810 to terminate within the second arm 1826.

FIG. 18 further illustrates a power source 1846a. In a preferred implementation, the power source 1846a is housed internally within a second temple portion 1828 of the second arm 1826, and more preferably within a second anterior portion 1828a of the second temple portion 1828 of the second arm 1826. The power source 1846a may be a portable power source, such as a battery or a super-capacitor (i.e., capacitor with capacitance on the order of 0.01 F or greater). In addition, where the power source 1846a is a battery, the battery can be rechargeable (i.e., a user inserts an external charging cord into glasses 1800 to charge the battery comprising the power source 1846a), or replaceable (i.e., the glasses 1800 include a removable cover for removing and replacing the battery or batteries comprising the power source 1846a). In implementations where the power source 1846a is one or more replaceable batteries, circuitry may be housed within either of the arms 1818 and 1826, and more specifically within either of the first and second temple portions 1822 and 1828, to receive the battery or batteries and provide an electrical connection between the battery or batteries and the radio 1840. In other words, the circuitry is communicatively coupleable to the replaceable battery or batteries comprising the power source 1846a. However one of skill in the art will appreciate that in implementations where the power source 1846a is a rechargeable battery or a super-capacitor, the same or substantially similar circuitry may be present to connect the power source 1846a to the radio 1840. The power source 1846a is electrically coupled to the radio 1840 by wire 1848a to transmit electric current from the power source 1846a to power the radio 1840, as well as any other electronic components housed within the first temple portion 1822 of the first arm 1818.

In an implementation, the wire 1848a passes internally from the power source 1846a housed within the second temple portion 1828, through a second aperture (not shown) in the second arm 1826, the second rim 1810, the bridge 1816, the first rim 1804, the first aperture (not shown) to the radio 1840 in the first temple portion 1822. As with the antenna 1801, the wire 1848a can pass through any of the elements of the front eyeglass frame 1802, irrespective of the location of the antenna 1801. For example, in various implementations the wire 1848a passes internally through the second upper peripheral portion 1812 of the second rim 1810, the bridge 1816, and the first upper peripheral portion 1806 of the first rim 1804. In other implementations, the wire 1848a passes through the second lower peripheral portion 1814, the bridge 1816, and the first upper peripheral portion 1806 of the first rim 1804. In alternative implementations, the wire 1848a passes through the second upper peripheral portion 1812, the bridge 1816, and the first lower peripheral portion 1808. Accordingly, implementations of the present disclosure are not limited by the path of the wire 1848a through the front eyeglass frame 1802.

In other variations, the power source and wire are located within the first temple portion 1818 along with the radio 1840, as represented by dashed lines 1846b and 1848b, respectively. In such an implementation, the wire 1848b preferably does not pass through any portion of the front eyeglass frame 1802. Rather, the power source 1846b is housed proximate the radio 1840 and electrically coupled to radio 1840 by wire 1848b. It may even be possible to include the power source 1846b within a first anterior portion 1822b of the first temple portion 1822 or a second anterior portion 1828b of the second temple portion 1828. In other words, in an implementation, the power source 1846b is located within the first anterior portion 1822b proximate a distal end 1844 of the first arm 1818 or within the second anterior portion 1828b of the second temple portion 1828.

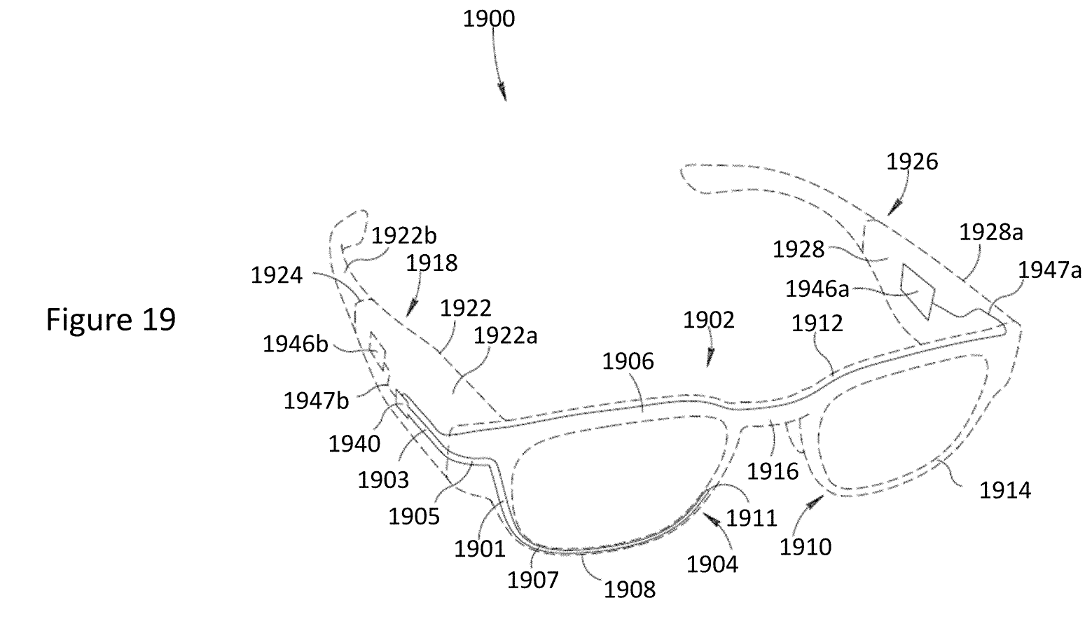

FIG. 19 is a perspective view of an alternative exemplary implementation of eyeglasses 1900, having an antenna 1901 incorporated in the eyeglasses 1900. For ease of recognition in the drawings, eyeglasses 1900 are represented by dashed lines and certain internal features, such as the frame portions and apertures of arms 1918 and 1926 are not shown, although one of skill in the art will appreciate that such features are present within implementations of the eyeglasses 1900.

The eyeglasses 1900 include first and second arms 1918 and 1926 coupled to a front eyeglass frame 1902. The front eyeglass frame 1902 includes a first rim 1904 having a first upper peripheral portion 1906 and a first lower peripheral portion 1908 and a second rim 1910 having a second upper peripheral portion 1912 and a second lower peripheral portion 1914. The first rim 1904 is securely physically coupled to the second rim 1910 by a bridge 1916. The first arm 1918 includes a first temple portion 1922, which may be separated into a first anterior portion 1922a and a first posterior portion 1922b by a hinge 1924, as described herein. Similarly, the second arm 1926 includes a second temple portion 1928, which may include a second anterior portion 1928a.

In the illustrated implementation, a radio 1940 is housed within the first temple portion 1922 of the first arm 1918, and more preferably, within the first anterior portion 1922a, although it may also be possible to house the radio 1940 in a first posterior portion 1922b of the first temple portion 1922. In the illustrated implementation, the antenna 1901 is communicatively coupled to the radio 1940 and extends internally along at least a portion of the first rim 1904. In other implementations, the antenna 1901 extends internally from the radio 1940, through part of the first temple portion 1922, through the first aperture (not shown), and along the first lower peripheral portion 1908 to terminate proximate the bridge 1916. In other words, in this implementation, a second distal end 1911 of the antenna 1901 is located within the first rim 1904, and more specifically proximate the first lower peripheral portion 1908 and the bridge 1916.

It is also possible for the antenna 1901 to extend along the first lower peripheral portion 1908 and beyond the bridge 1916 to terminate in either the second upper peripheral portion 1912 or the second lower peripheral portion 1914. Similarly, it is possible for the antenna 1901 to extend along at least a portion of the first upper peripheral portion 1906 to terminate proximate the bridge 1916, within the bridge 1916, or terminate beyond the bridge 1916 in either the second upper peripheral portion 1912 or the second lower peripheral portion 1914, although not specifically shown. Further, in an implementation, the antenna 1901 extends around only the first rim 1904, such that the antenna 1901 extends along the first lower peripheral portion 1908 to terminate with the first upper peripheral portion 1906. Accordingly, the antenna 1901 may extend along any portion of the front eyeglass frame 1902 and terminate with the same, or a different portion of any part of the front eyeglass frame 1902.

In the illustrated implementation, the antenna 1901 includes a first portion 1903, second portion 1905, and third portion 1907. The first portion 1903 is located at least partially within the first temple portion 1922, the second portion 1905 is located at least partially in the first rim 1904, and the third portion 1907 is located at least partially within the first lower peripheral portion 1908 of the first rim 1904.

FIG. 19 also illustrates a power source 1946a, which may be a portable power source, such as a battery or a super-capacitor, as above. The power source 1946a is electrically coupled to the radio 1940 by a first electrically conductive path 1947a extending along a portion of the second rim 1910, the bridge 1916, and a portion of the first rim 1904. In other implementations, the first electrically conductive path 1947a passes internally along the second lower peripheral portion 1914, the bridge 1916 and the first upper peripheral portion 1906 of the first rim 1904, while in further alternative implementations, the first electrically conductive path 1947a passes internally along the second lower peripheral portion 1914 of the second rim 1910, the bridge 1916, and the first lower peripheral portion 1908 of the first rim 1904. The first electrically conductive path 1947a may also pass internally along the second upper peripheral portion 1912, the bridge 1916, and the first upper peripheral portion 1906 of the first rim 1904.

In addition, it is possible to have the power source, represented by dashed lines 1946b, located in the first temple portion 1922, which is to say that the power source 1946b can be located in the same arm 1918 as other electronic components, such as the radio 1940, or display producing components, and a second electrically conductive path 1947b electrically couples the radio 1940 to the power source 1946b. In this case, the second electrically conductive path 1947b extends along at least a portion of the first arm 1918, or more preferably, along at least a portion of the first temple portion 1922 and does not necessarily extend along any portion of the front eyeglass frame 1902. Further, the first and second electrically conductive paths 1947a and 1947b may be wires, although other materials capable of transmitting electric energy may be used. Accordingly, one of skill in the art will appreciate that the implementations of the present disclosure are not limited by the placement of the electrically conductive paths 1947a and 1947b and the antenna 1901 within the eyeglasses 1900. Rather, any location of the antenna may be used along with any combination of the electrically conductive paths 1947a and 1947b either internal to, or external to the eyeglasses 1900.

One of skill in the art will further appreciate that at least one of the arms 1918 and 1926 or more preferably at least one of the temple portions 1922 and 1928 may house additional electronic components, such as one or more display-producing components, a printed circuit board, a processor, and a non-transitory processor-readable storage medium or memory, among others. Further, one of skill in the art will appreciate that the arms 1918 and 1926 and the front eyeglass frame 1902 may be formed of various materials, for example various plastics (i.e., zylonite or cellulose acetate, cellulose acetate propionate, nylon, blended nylon, castor oil-based plastics) or metals (i.e., stainless steel, aluminum, titanium, monel, flexon, beryllium, and alloys of any of the above in combination with other metals), among others. Further, although the antenna 1901 and radio 1940 are illustrated herein as being housed in the first temple portion 1922, one of skill in the art will understand that the antenna 1901 and radio 1940 can be housed in the second temple portion 1928, or in other locations with the eyeglasses 1900.

Exemplary systems like those shown in FIGS. 14-19 can be found in U.S. Provisional Patent Application Ser. No. 62/609,607, U.S. Provisional Patent Application Ser. No. 62/609,681, and/or U.S. Provisional Patent Application Ser. No. 62/670,200. In some implementations, one or more optical fiber(s) may be used to guide light signals along some of the paths illustrated herein.

The WHUDs described herein may include one or more sensor(s) (e.g., microphone, camera, thermometer, compass, altimeter, and/or others) for collecting data from the user's environment. For example, one or more camera(s) may be used to provide feedback to the processor of the WHUD and influence where on the display(s) any given image should be displayed.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087, U.S. Non-Provisional patent application Ser. No. 14/155,107, PCT Patent Application PCT/US2014/057029, and/or U.S. Provisional Patent Application Ser. No. 62/236,060.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: U.S. Non-Provisional patent application Ser. No. 15/145,576, U.S. Non-Provisional patent application Ser. No. 15/167,458, U.S. Non-Provisional patent application Ser. No. 15/046,254 now published as U.S. Pat. No. 9,989,764, U.S. Provisional Patent Application Ser. No. 61/928,568, now U.S. Non-Provisional patent application Ser. No. 14/599,279, U.S. Non-Provisional patent application Ser. No. 14/155,087, U.S. Non-Provisional patent application Ser. No. 14/155,107, PCT Patent Application PCT/US2014/057029, U.S. Provisional Patent Application Ser. No. 62/236,060, U.S. Provisional Patent Application Ser. No. 61/989,848 (now U.S. Non-Provisional patent application Ser. No. 14/704,663), U.S. Provisional Patent Application Ser. No. 62/609,607, U.S. Provisional Patent Application Ser. No. 62/609,681, and/or U.S. Provisional Patent Application Ser. No. 62/670,200, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display (“WHUD”) comprising:
a support structure to be worn on a head of a user, the support structure comprising a first arm to be positioned on a first side of the head of the user, a second arm to be positioned on a second side of the head of the user opposite the first side of the head of the user, and a front frame to be positioned on a front side of the head of the user, the front frame physically coupled to the first arm and the second arm;
an optical combiner carried by the front frame to be positioned within a field of view of an eye of the user;
a light engine carried by the first arm, the light engine positioned and oriented to output display light to the optical combiner;
a battery carried by the second arm; and
at least one connector which electrically couples the battery to the light engine,
wherein the optical combiner is positioned and oriented to direct the display light towards the eye of the user.

2. The WHUD of claim 1, further comprising at least one processor carried by the first arm and a non-transitory processor readable medium carried by the first arm, wherein the at least one processor is communicatively coupled to the non-transitory processor readable medium and the light engine, and the at least one connector electrically couples the battery to the at least one processor and to the non-transitory processor readable storage medium.

3. The WHUD of claim 2, further comprising a power supply circuit carried by the first arm, wherein the at least one connector directly electrically couples the battery to the power supply circuit, and the power supply circuit is electrically coupled to the at least one processor, the non-transitory processor readable medium, and the light engine.

4. The WHUD of claim 2, wherein the at least one connector directly electrically couples the battery to the at least one processor, the non-transitory processor readable medium, and the light engine.

5. The WHUD of claim 1, further comprising a wireless communication module operable to provide wireless communications with one or more other electronic devices, wherein at least a portion of the wireless communication module is positioned on the support structure relative to the light engine.

6. The WHUD of claim 5 wherein the wireless communication module comprises a wireless receiver communicatively coupled to the light engine, wherein the at least one connector electrically couples the battery to the wireless receiver.

7. The WHUD of claim 1, the first arm to be positioned on a right side of the head of the user and the second arm to be positioned on a left side of the head of a user.

8. The WHUD of claim 1, the first arm to be positioned on a left side of the head of the user and the second arm to be positioned on a right side of the head of the user.

9. The WHUD of claim 1 wherein the light engine comprises a projector, a scanning laser projector, a microdisplay, or a white-light source.

10. The WHUD of claim 1 wherein the optical combiner comprises: a lightguide, at least one hologram, at least one prism, a diffraction grating, at least one light reflector, or at least one light refractor positioned and oriented to redirect the display light towards the eye of the user.

11. The WHUD of claim 1, wherein the optical combiner is carried by a lens carried by the front frame of the support structure.

12. The WHUD of claim 1 wherein the light engine includes a scanning laser projector and the optical combiner includes at least one hologram, wherein the scanning laser projector is positioned and oriented to project laser light onto the at least one hologram, and the at least one hologram is positioned and oriented to redirect the laser light towards an eye of the user.

13. The WHUD of claim 1, further comprising a light redirector, wherein:
the light redirector is positioned and oriented to receive the display light output by the light engine and to redirect the display light into a periphery of the optical combiner; and
the optical combiner comprises a lightguide and an out-coupler, wherein the lightguide is positioned and oriented to receive the display light from the light redirector and direct the display light to the out-coupler, and the out-coupler is positioned and oriented to redirect the display light towards the eye of the user.

14. The WHUD of claim 1, wherein the at least one connector is carried by the front frame.

15. The WHUD of claim 1 the at least one connector to be positioned behind a head of the user.

16. The WHUD of claim 1, wherein the front frame is directly physically coupled to the first arm and the second arm.

17. The WHUD of claim 1, wherein the front frame is indirectly physically coupled to the first arm via a first intermediary coupler, and the front frame is indirectly physically coupled to the second arm via a second intermediary coupler.

18. A wearable heads-up display (“WHUD”) comprising:
a support structure to be worn on a head of a user, the support structure comprising a first arm to be positioned on a first side of the head of the user, a second arm to be positioned on a second side of the head of the user opposite the first side of the head of the user, and a front frame to be positioned on a front side of the head of the user, the front frame physically coupled to the first arm and the second arm;
an optical combiner carried by the front frame to be positioned within a field of view of an eye of the user;
a light engine carried by the front frame, the light engine positioned and oriented to output display light into a periphery of the optical combiner;
a non-transitory processor-readable medium carried by the first arm;
at least one processor carried by the first arm, the at least one processor communicatively coupled to the non-transitory processor readable medium and the light engine;
a battery carried by the second arm; and
at least one connector which electrically couples the battery to the light engine, the non-transitory processor-readable medium, and the at least one processor,
wherein the optical combiner is positioned and oriented to direct the display light towards the eye of the user.

19. The WHUD of claim 18, further comprising a power supply circuit carried by the first arm, wherein the at least one connector directly electrically couples the battery to the power supply circuit, and the power supply circuit is electrically coupled to the at least one processor, the non-transitory processor readable medium, and the light engine.

20. The WHUD of claim 18, wherein the at least one connector directly electrically couples the battery to the at least one processor, the non-transitory processor readable medium, and the light engine.

21. The WHUD of claim 18, further comprising a wireless communication module operable to provide wireless communications with one or more other electronic devices, wherein at least a portion of the wireless communication module is positioned on the support structure relative to the light engine.

22. The WHUD of claim 21 wherein the wireless communication module comprises a wireless receiver communicatively coupled to the light engine, wherein the at least one connector electrically couples the battery to the wireless receiver.

23. The WHUD of claim 18, the first arm to be positioned on a right side of the head of the user and the second arm to be positioned on a left side of the head of a user.

24. The WHUD of claim 18, the first arm to be positioned on a left side of the head of the user and the second arm to be positioned on a right side of the head of the user.

25. The WHUD of claim 18 wherein the light engine comprises a projector, a scanning laser projector, a microdisplay, or a white-light source.

26. The WHUD of claim 18 wherein the optical combiner comprises a lightguide and an out-coupler, wherein the lightguide is positioned and oriented to receive the display light from the light engine and direct the display light to the out-coupler, and the out-coupler is positioned and oriented to redirect the display light towards the eye of the user.

27. The WHUD of claim 18 wherein the optical combiner is carried by a lens carried by the front frame of the support structure.

28. The WHUD of claim 18, wherein the at least one connector is carried by the front frame.

29. The WHUD of claim 18, the at least one connector to be positioned behind a head of the user.

30. The WHUD of claim 18, wherein the front frame is directly physically coupled to the first arm and the second arm.

31. The WHUD of claim 18, wherein the front frame is indirectly physically coupled to the first arm via a first intermediary coupler, and the front frame is indirectly physically coupled to the second arm via a second intermediary coupler.
